(19) United States
(12) Patent Application Publication
(10) Pub. No.: US 2003/0099456 A1
(43) Pub. Date: May 29, 2003

(54) Image recorder

(75) Inventors: Akira Ohmura, Kawasaki-shi (JP); Masahide Tanaka, Kawasaki-shi (JP)

Correspondence Address: OLIFF & BERRIDGE, PLC, P.O. BOX 19928, ALEXANDRIA, VA, 22320, US

(73) Assignee: Nikon Corporation & Nikon Technologies Inc.

(21) Appl. No.: 09/748,206

(22) Filed: Dec. 27, 2000

(30) Foreign Application Priority Data
Jan. 6, 2000 (JP) 2000-5723
Jan. 6, 2000 (JP) 2000-5724
Jan. 6, 2000 (JP) 2000-5725
Jan. 6, 2000 (JP) 2000-5726

(51) Int. Cl. H04N 5/76; H04N 5/225

(52) U.S. Cl. 386/46; 386/117

(57) ABSTRACT

An image recorder has a storage for a visual broadcast program. The image recorder makes a question of whether or not the data of the visual broadcast program is to be automatically deleted from the storage after the playback of the visual broadcast program is terminated. The image recorder makes it possible to interrupt the storage of a selected one of a plurality of visual broadcast programs with the storage of at least another visual broadcast program continued. The image recorder is capable of recording both the data of visual broadcast program and digital image data from another source, the priority is given to the data of visual broadcast program over the digital image data.

### BACKGROUND OF THE INVENTION

This application is based upon and claims priority of Japanese Patent Application No. 2000-005723 filed on Jan. 6, 2000, No. 2000-005724 filed on Jan. 6, 2000, No. 2000-005725 filed on Jan. 6, 2000, and No. 2000-005726 filed on Jan. 6, 2000, the contents being incorporated herein by reference.

1. Field of the Invention

The present invention relates to a storage device for storing digital still images, and to a recorder for storing broadcasting programs received by a device such as a TV tuner.

2. Description of Related Art

Conventionally, a still image picture has been viewed in the form of a print. Prints are usually preserved in bags or small albums with pockets. Depending on a purpose, prints are sometimes arranged and preserved in usual photograph albums after unnecessary prints are removed. However, since these prints are not always kept at a regular place in a house, prints tend to get lost for a long time. In particular, in the case where prints are reserved in the bags or the small albums instead of being contained in the usual photograph album, they often get lost.

Since debut of a digital camera, it becomes possible to store still images into a personal computer, and still images can be stored in a database.

Furthermore, so-called image filing system and electronic album device, which are used for storing still images taken by a digital camera, have been proposed. For example, Japanese Patent Publication No. 63-142963, Japanese Patent Publication No. 7-87432, Japanese Patent Publication No. 7-282077, Japanese Patent Publication No. 7-182366, and Japanese Patent Publication No. 11-32285 are known. Still images are sometime viewed on a TV screen at home.

However, storing electric images into a computer is not prevailing yet. One reason for this is that it is troublesome to operate a device in order to arrange and store still images that are taken by a digital still camera.

Meanwhile, VCR is widely used in order to record broadcasting programs. VCR is suitable for recording broadcasting programs because recording motion pictures need a large capacity of storage media, and a VCR tape meets this requirement. Recently, other media, which has an ability of random-accessing and high recording density, such as a hard disk, has been further increasing its high density, resulting in a large-capacity recording device that uses such a high-density hard disk. This recording device with the random-accessing ability has various functions that a conventional VCR cannot carry out.

### SUMMARY OF THE INVENTION

In order to overcome the problems and disadvantages, the invention provides an image recorder comprising a storage that stores data of a visual broadcast program and a questioner that makes a question of whether or not the data of the visual broadcast program is to be automatically deleted from the storage after the playback of the visual broadcast program is terminated. This makes it possible to avoid the data of the visual broadcast programs remaining meaninglessly in the storage.

According to the another feature of the invention, an image recorder comprises a recording controller that interrupts storage of a selected one of a plurality of broadcast programs with at least another visual broadcast program continued to be stored. This is advantageous for a free selection of the broadcast programs to be stored.

According to still another feature of the invention, both the data of visual broadcast program and a digital image data from another source can be stored into the storage. Upon storing the data, the priority is given to the data of visual broadcast program over the digital image data. This makes it possible to avoid the storage of the data of visual broadcast program being interrupted by storage of the digital image data from another source.

According to a further feature of the invention, an image recorder comprises a first receiver that receives data of a visual broadcast program and a second receiver that receives a digital still image data taken by a digital still camera. The image recorder further comprises a manually operable controller that controls the playback both on the basis of the data of visual broadcast program and on the basis of the digital still image data. This simplifies the manual operation to control the recorder.

### BRIEF DESCRIPTION OF THE DRAWINGS

FIG. 1 is a front view of an image recorder.

FIG. 2 is a block diagram showing a structure of the image recorder.

FIG. 3 is an external view of a remote control.

FIG. 4 is an explanatory view showing a display of the remote control.

FIG. 5 is a flowchart showing selecting control of selecting an operation item.

FIG. 6 is a flowchart showing control of recording a broadcasting program in the case where a CM cut mode is set.

FIG. 7 is a flowchart showing control of playing back while the image recorder is recording a broadcasting program simultaneously.

FIG. 8 is a flowchart showing control of playing back recorded image data.

FIG. 9 is a flowchart showing control of playing back recorded image data.

FIG. 10 is a flowchart showing control of playing back image recorded data.

FIG. 11 is a flowchart showing control of starting the imager recorder when card memory is inserted into a card slot.

FIG. 12 is a flowchart showing control of recording and playing back still image data.

FIG. 13 is a flowchart showing detailed control of recording still image data.

FIG. 14 is a flowchart showing detailed control of playing back a still image data.

FIG. 15 is a block diagram showing a configuration of a docking station.

FIG. 16 is a block diagram showing a configuration of a digital camera.

FIG. 17 is a flowchart showing image transfer control executed by a CPU of the image recorder.

FIG. 18 is a flowchart of image transfer control executed by a CPU of the image recorder.

FIG. 19 is a flowchart showing signal transmission control.

FIG. 20 is a flowchart showing signal transmission control.

FIG. 21 is a flowchart showing signal transmission control.

FIG. 22 is a main flowchart showing an operation of the image recorder.

FIG. 23 shows a flowchart showing a startup process started by inserting the card memory.

FIG. 24 is a flowchart showing card insertion interruption.

FIG. 25 is a flowchart showing a detailed data-acquiring process of step S316 in FIG. 24.

FIG. 26 is a flowchart showing card extraction interruption.

FIG. 27 is a flowchart showing viewing interruption.

FIG. 28 is a flowchart showing a viewing process.

FIG. 29 is a flowchart showing main-power-off interruption.

### DETAILED DESCRIPTION OF THE PREFERRED EMBODIMENTS

[First Embodiment]

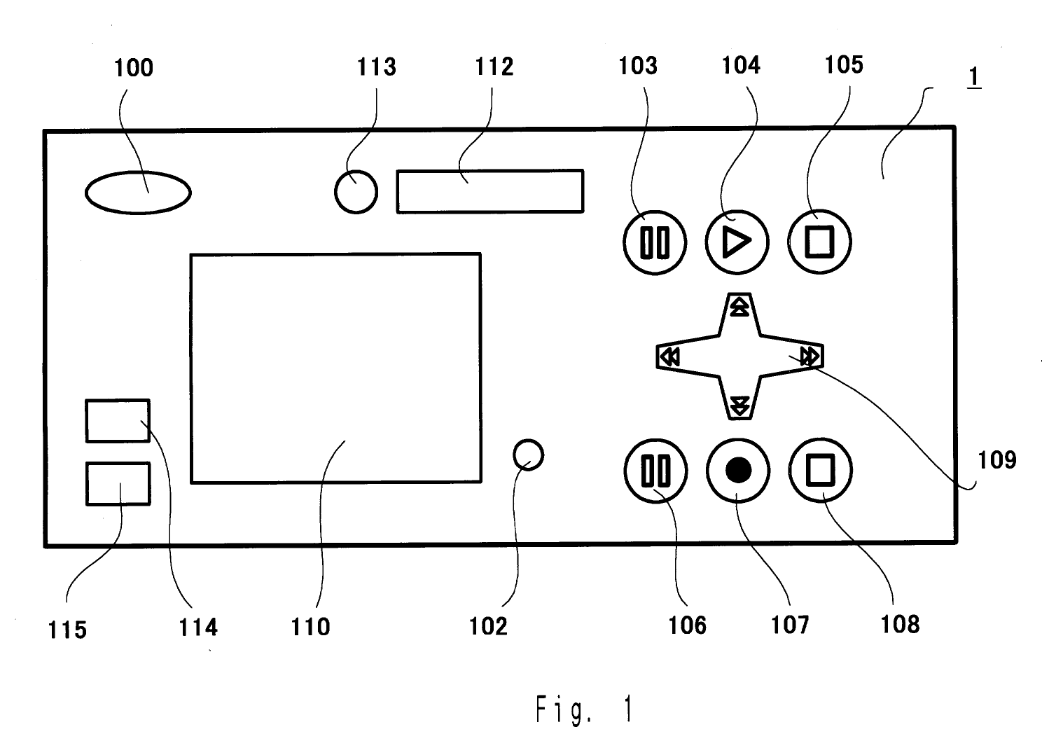

The following explains a First Embodiment of an image recorder in accordance with the present invention. FIG. 1 is a front view of the image recorder.

Card memory inserting opening 112 is used as an opening for inserting card memory when image data stored in the card memory, which is used for a device such as a digital camera, is transferred to image recorder 1. Card memory slot 122 is provided within card memory inserting opening 112, as described later. There are plural types of card memory that are used in such a thing as a digital camera. A plurality of openings and slots are possible in order to correspond to plural types of card memory. Eject button 113 is provided adjacent to card memory inserting opening 112. Eject button 113 ejects the card memory inserted in card memory slot 122. Display 110 displays broadcasting program information, the time of day, image recorder status such as “playing back” or “recording”, and the remaining capacity of hard disk 16. USB connector 115 enables image recorder 1 to communicate with other device having a USB interface. IEEE connector 114 enables image recorder 1 to communicate with a device, such as a digital camera, having an IEEE interface.

Image recorder 1 includes power button 100 for starting control of recording or playing back, select button 102, playback pause button 103, playback button 104, playback stop button 105, record pause button 106, record button 107, record stop button 108, and cross button 109. Three buttons including playback pause button 103, playback button 104, and playback stop button 105 are located closely with each other. Being a little apart from these three buttons, three buttons including record pause button 106, record button 107, and record stop button 108 are located closely with each other. Thus, by separating the buttons for playing back from the buttons for recording, operation mistakes are avoided. These buttons have the same function as that of buttons of remote control 24, which have the same named buttons. Since functions of these buttons will be explained later, upon explanation of remote control 24, explanation of them is omitted here. Although the explanation of these buttons will be made using the buttons of remote control 24, the explanation is applied to the buttons of image recorder 1.

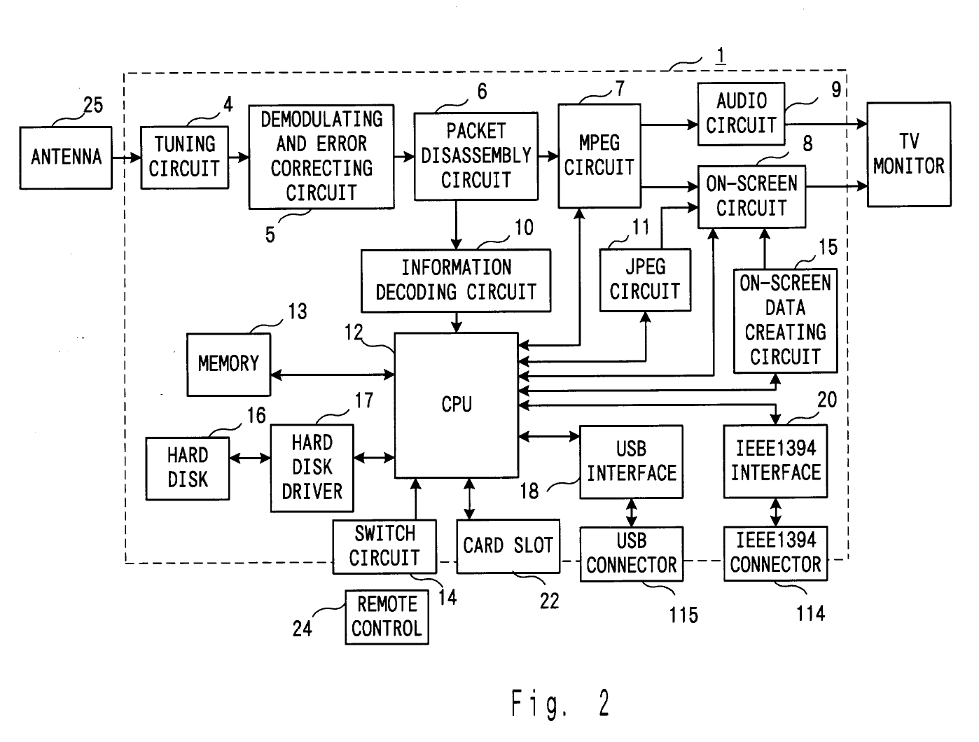

FIG. 2 is a block diagram showing a structure of the image recorder in accordance with an embodiment of the present invention.

Antenna 25 receives digital broadcasting signals transmitted from a broadcasting station and transfers output signals to tuning circuit 4. The broadcasting station compresses and codes a video signal of broadcasting program image in MPEG 2 format, and adds various data, such as information about a broadcasting program in HTML format, to the above-mentioned processed broadcasting program video signal, and then sends this signal as a digital signal. Tuning circuit 4 that is connected to antenna 25 chooses a specific transmission channel signal among digital signals received by antenna 25. Demodulating and error correcting circuit 5 demodulates and corrects the received signal, which is output from tuning circuit 4, by performing a demodulating and error-correction process such as QPSK. Packet disassembly circuit 6 disassembles a bit stream of the received data into a plurality of packets according to identifying information included in the bit stream, and outputs bit streams per packet, whereby the received data being disassembled into the broadcasting program image data and the added information data, which was added to the broadcasting program image data. MPEG circuit 7 decodes the broadcasting program image data in MPEG 2 format, which was disassembled by packet disassembly circuit 6, restoring an image and audio signal before encoded. Onscreen circuit 8 synthesizes an image signal output from MPEG circuit 7 and onscreen data created by onscreen data creating circuit 15. By onscreen circuit 8, a signal of information such as characters can be superimposed on an image signal output from MPEG circuit 7. Audio circuit 9 amplitudes a signal and performs other process in order to produce a sound corresponding to an image signal. Information decoding circuit 10 decodes the added information data that was disassembled by packet disassembly circuit 6. JPEG circuit 11 decodes JPEG format image data included in the added information data, and transferred from the digital camera.

CPU 12, which is electrically connected to each circuit of image recorder 1, controls each circuit of image recorder 1, serving as a circuit for controlling all functions of image recorder 1. CPU 12 includes a ROM that stores character data such as “playing back” and “recording” that are displayed responsive to an operation of the playback button or the recording button, and stores the broadcasting program data into control image recorder 1. Memory 13 stores various data temporarily. Switch circuit 14 detects a signal responsive to an operation of a button such as the playback button or the stop button, and then transmits the signal to CPU 12. Switch circuit 14 transmits a signal from remote control 24 to CPU 12. Onscreen data creating circuit 15 creates onscreen data such as character data, involving “playback” and “record” that are displayed on the TV screen responsive to operations of the playback button and record button, and HTML data selected from the information data added to the broadcasting program data. Hard disk 16 is large capacity memory and stores broadcasting program image data thereon instead of videotape recording. Hard disk 16 also stores image data transferred from the digital camera. Such large capacity memory as a DVD disk is possible instead of the hard disk. Hard disk driver 17 controls hard disk 16 according to instructions from CPU 12.

USB interface 18 is a circuit for communicating with external circuits by using signals in conformity with the USB standard. USB connector 115 connects with a USB cable that transmits signals between USB interfaces. IEEEE 1394 interface 20 communicates with external devices by using signals in conformity with the IEEE 1394 standard. IEEE 1394 connector 114 connects with an IEEE 1394 cable that transmits signals between IEEEE 1394 interfaces. Card slot 22 includes a terminal that connects with card memory such as Compactflash, Smartmedia, and Memorystick, and reads data from card memory or writes data into the card memory. When card slot 22 detects that the card memory is inserted into card slot 22, card slot 22 transfers a signal to CPU 12. With regard to above-mentioned memory cards, Compactflash, Smartmedia, and Memorystick, are trade names for San Disk Co., USA, Toshiba Co., and Sony Co., respectively. Card driver 23 is used for reading data from the card memory inserted into card slot 22 and writing data into the card memory.

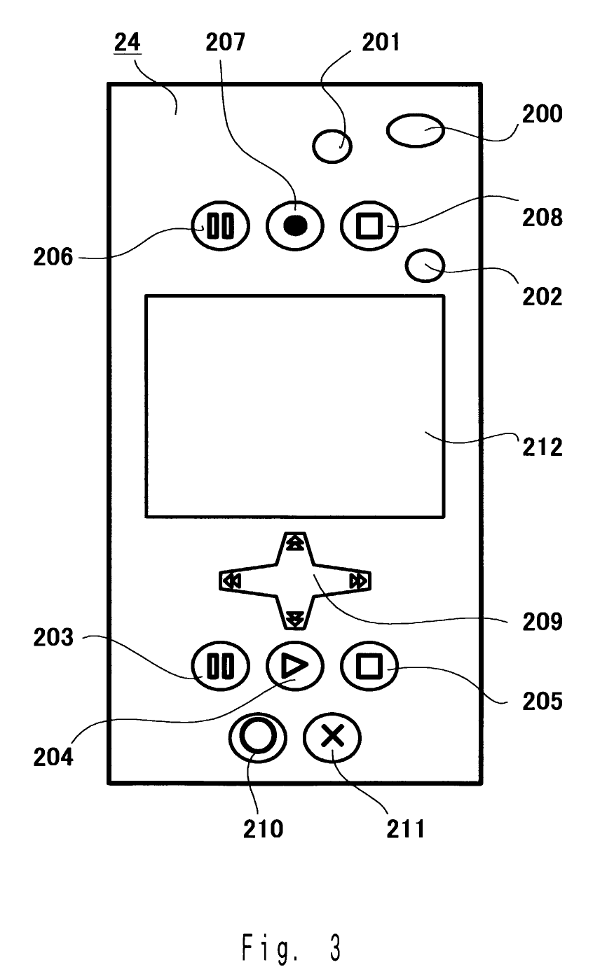

Remote control 24 includes a plurality of buttons such as playback button 104 and record button 107, and is operated in order to perform various functions of image recorder 1. Remote control 24 obtains information from image recorder 1 by receiving signals from it, and also transfers operation signals to image recorder 1. Obtained information from image recorder 1 is used for displaying the information onto display 212, as described later. The following is an explanation of remote control, referring to FIG. 3.

FIG. 3 is an external view of remote control 24. Remote control 24 includes power button 200, TV/image recorder change button 201, select button 202, playback pause button 203, playback button 204, playback stop button 205, record pause button 206, record button 207, record stop button 208, cross button 209, ∘ button 210, X button 211, and display 212.

Power button 200 is an on/off button for a main power source of image recorder 1. TV/image recorder change button 201 performs control of switching between a television set and image recorder 1. By operating this button, the television set can display images transmitted from either of image recorder 1 and a device other than image recorder 1, e.g., television set itself or other image device. Select button 202 is operated to select an image among a plurality of images of TV program and other still images, displayed on display 212, for purpose of recording or playing back the image. An operation of select button 202 leads to a select mode, and during the select mode, an image item is selected by operating cross button 209. Playback pause button 203 temporarily stops a playback of recorded data. During a pausing time, an operation of playback pause button 203 resumes the playback of data. Playback button 204 plays back recorded data. Playback stop button 205 stops a playback of data. Record pause button 206 temporarily stops recording data. During a pausing time, an operation of record pause button 206 resumes recording data. Record button 207 is used to start to record broadcasting program image data, and also used to transfer still image from a card memory to hard disk 16. Record stop button 208 stops recording. Thus, image recorder 1 and remote control 24 have stop buttons and pause buttons for each of recording and playing back. The reason for having these buttons is that the present image recorder can record and play back simultaneously, so that it is necessary to operate these buttons independently. Furthermore, since this image recorder can record and play back a plurality of data simultaneously, such a modification is possible that image recorder 1 has a plurality of stop buttons and pause buttons for recording or playing back a plurality of data simultaneously. However, in the image recorder of the present invention, without increasing the number of buttons, images or matters of interest are selected through display on display 110 or 212 and processed by operating buttons such as the record, playback and stop button.

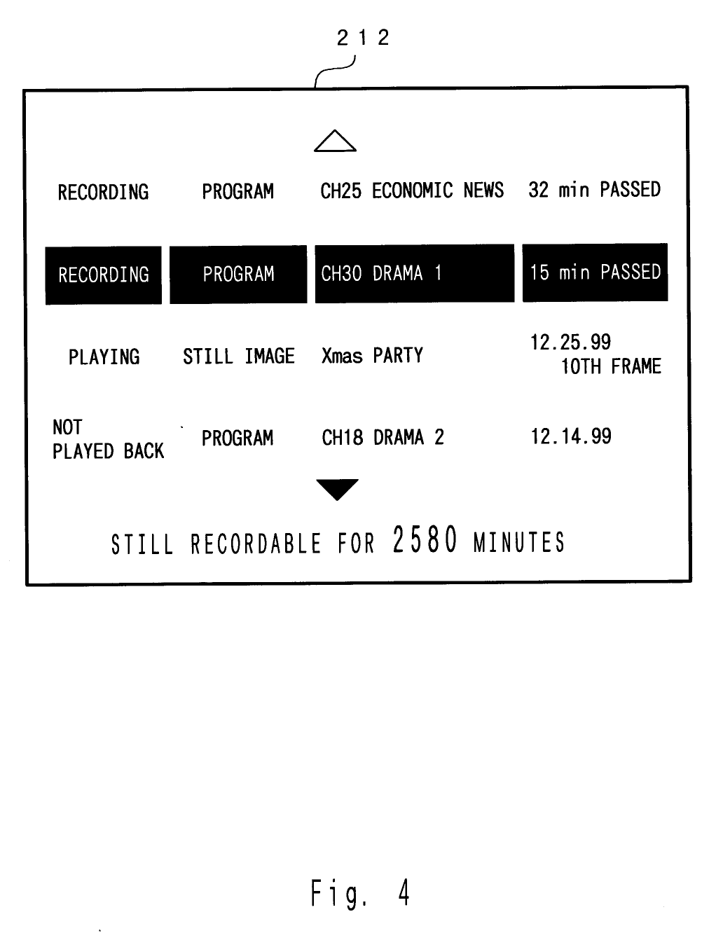

Cross button 209 is used for moving a cursor across the screen of the display upon selecting images or matters of interest. When viewing TV program, push of the left or right end of cross button 209 changes TV channel. In this case, the TV channel is changed in order of precedence, for example, order of viewing hours or viewing times of broadcasting programs. That is, by storing a time period of a day of the week for a broadcasting program viewed frequently, when a user operates cross button 209, frequently viewed broadcasting program in the current time period of a week is selected automatically in order of precedence. Furthermore, during playing back, push of the left or right end of cross button 209 allows image recorder 1 to forward frames fast in movie viewing or transfer a next image in still image viewing. Furthermore, push of the upper or lower end of cross button 209 allows image recorder 1 to control a sound level. In the case where a status is select mode after select button 202 is operated, cross button 209 is used for selecting a matter of interest on the display. ∘ button 210 is used for giving an answer “yes” for various questions displayed on the TV screen or display 212. X button 211 is used for giving an answer “no” for various questions displayed on the TV screen or display 212. Display 212 displays information such as a recording status of the current recording broadcasting program. When image recorder 1 is in a status of recording or playing back a plurality of broadcasting programs, image recorder 1 allows the TV monitor to display the status in such a way as to indicate an operated image in reverse video. The following explains an example screen on display 212 with help of FIG. 4.

FIG. 4 is a view displayed on display 212 of remote control 24. Referring to FIG. 4, display 212 has a screen space containing a plurality of rows and columns. Information on one broadcasting program or one still image is assigned to one row. Columns are used as follows. In the first column, the current status of image recorder, such as “recording”, “playing back”, “preselected”, and “not played back”, is displayed. In the second column, a type of data item, such as “still image” and “broadcasting program”, is displayed. In the third column, such things as a broadcasting program title of a data item and a file name are displayed. In the fourth column, such things as the time and date, and elapsed time in which a data item has been recorded are displayed. Furthermore, other than the above mentioned information, such things as the remaining capacity of hard disk 16, various questions for users, and warnings transmitted from image recorder 1 are also displayed.

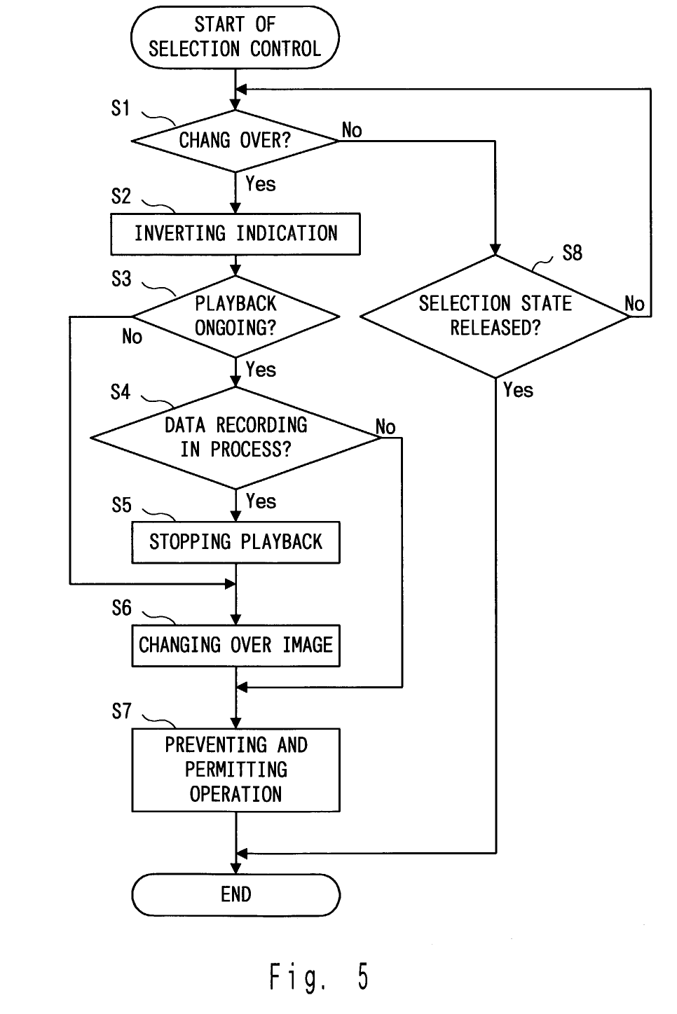

If image recorder 1 has no display, a user cannot make sure which broadcasting program is stopped at the time when he stops one of broadcasting programs, e.g., broadcasting program1 and 2, which are being recorded simultaneously, by operating record stop button 208. If he uses display 212, he can confirm an operated broadcasting program item easily and correctly. Furthermore, when an operation item is changed into other item by using select button 202 and cross button 209, the selected item is displayed on display 212 in reverse video, and then the image on TV screen is changed into a selected one. The following specifically explains selecting control with help of FIG. 5.

FIG. 5 is a flowchart showing selecting control for selecting an operation item. This flow is processed by CPU 12 of image recorder 1 based upon signals transferred from remote control 24, then processed results are received by remote control 24 and displayed. The flow chart shown in FIG. 5 starts by operating select button 202 and moves to a select mode. Until cross button 209 is operated after select button 202 is operated, data of the current operation item remains being displayed in reverse video.

In step S1, cross button 209 is operated, and it is determined whether data of an operation item has been changed, if the data of the operation item has been changed, then the flow is advanced to step S2, if not, the flow is advanced to step S8. In step S2, information corresponding to selected data is displayed in reverse video. In step S3, it is determined whether image recorder 1 is during a playback. If image recorder 1 is during a playback, then the flow is advanced to step S4, if not, then the flow is advanced to step S6. In step S4, it is determined whether data of a newly selected operation item is being recorded. If not, that is, if the data is data to be played back, then the flow is advanced to step S7. In step S5, the current playing back is stopped in order to play back the newly selected data. In step S6, the current data image is changed to a newly selected data image on the TV monitor. For example, when an image data of a broadcasting program that is being recorded is selected, this broadcasting program is displayed on the TV monitor. In step S7, recording, playing back, and stopping operations that have been selected before are prevented, and an operation such as stopping for newly selected data is allowed.

In step S8, select button 202 is operated, and it is determined whether a selected status has been canceled. If the selected status has been canceled, then this flow is completed. If not, the flow is returned to step S1. The following explains a function of recording a broadcasting program in accordance with the First Embodiment of the present invention.

Image recorder 1 includes a CM-cut function of cutting commercials (CM).

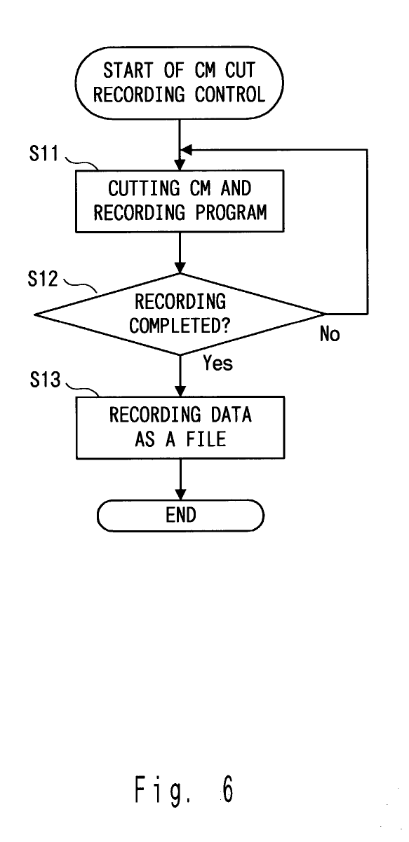

When this function is used during recording, recorded image data of a broadcasting program is composed of plural pieces of data separated at CM cutting position. By combining the separated plural pieces of data, image recorder 1 of the First Embodiment creates one file of data and stores the file into the hard disk. Alternatively, it is possible to store the plural pieces of data as separate files. In this case, the plural pieces of data are stored so that they are associated with each other. By storing the data in these manners, it is possible to view a consecutive broadcasting program, and the playback operation only needs one press of the playback button. The following explains control of recording a broadcasting program in a CM cut mode in which CM cut function is performed, with the help of FIG. 6.

FIG. 6 is a flowchart showing control of recording a broadcasting program in the case where a CM cut mode is set. In step S11, broadcasting program data is stored into hard disk 16 in MPEG 2 format, performing CM cut. In this case, when a commercial time begins, recording of the broadcasting program is stopped, and restarted when the commercial time ends. A broadcasting program until the commercial time has begun is stored into hard disk 16 as one file, and image recorder 1 repeats this process to the end of the broadcasting program, creating a plurality of files. Thus, since a plurality of broadcasting program files are stored separately into hard disk 16, even if a trouble arises due to some cause during recording the broadcasting program, it is possible to play back the broadcasting program except for the troubled one and to avoid loosing the entire broadcasting program storage. In step S12, it is determined whether storage of the broadcasting program is completed. If completed, the flow is advanced to step S13, if not, the flow is returned to step S11 and recording is continued. In step S13, a plurality of files created during the whole broadcasting program time are combined with one file. A file title is named from such things as a broadcasting program title and the day and time at recording. Furthermore, Internet address information and files in HTML format, which are attended to and received along with the broadcasting program, are stored into hard disk 16, being associated with the broadcasting program image data so that the attended data can be displayed when the broadcasting program is played back.

Furthermore, in accordance with the First Embodiment of the present invention, by storing CM data that is cut during recording, it is possible to insert the CM part according to a user's arbitrary instruction during a playback of the broadcasting program. For example, when a user is tired from a long time viewing of a broadcasting program, and takes a rest, it is possible to play back only CM part that has been stored during the broadcasting program.

Furthermore, in accordance with the First Embodiment of the present invention, when a user restarts playing back a broadcasting program after a rest, it is possible to restart the broadcasting program from a point of some time before. For example, it is possible to return to a point at which a continuous sound starts and restart the broadcasting program from this point. This leads to easy comprehension of the broadcasting program. It is not necessary to restart the broadcasting program from the beginning. In particular, in the case where a playback is performed after a considerable time has passed, an advantage of the above-mentioned control is great.

Although an explanation of the CM-cut function that decreases the quantity of recorded broadcasting program is made, it is also possible to store the whole broadcasting program including CM part into hard disk 16, and to remove CM part upon playing back the broadcasting program. In this case, signals identifying CM parts are stored into hard disk 16 together with the CM parts, and when the broadcasting program is played back, CM parts are identified and removed from the broadcasting programs. Furthermore, such a modification is possible that address information on CM parts is stored into hard disk 16 and the CM parts are removed from the broadcasting program according to the stored address.

Furthermore, in accordance with image recorder 1 of the First Embodiment of the present invention, it is possible to read stored data from hard disk 16 while storing the same data into hard disk 16 simultaneously. This allows image recorder 1 to play back a recorded broadcasting program of some time before, while recording the same broadcasting program simultaneously.

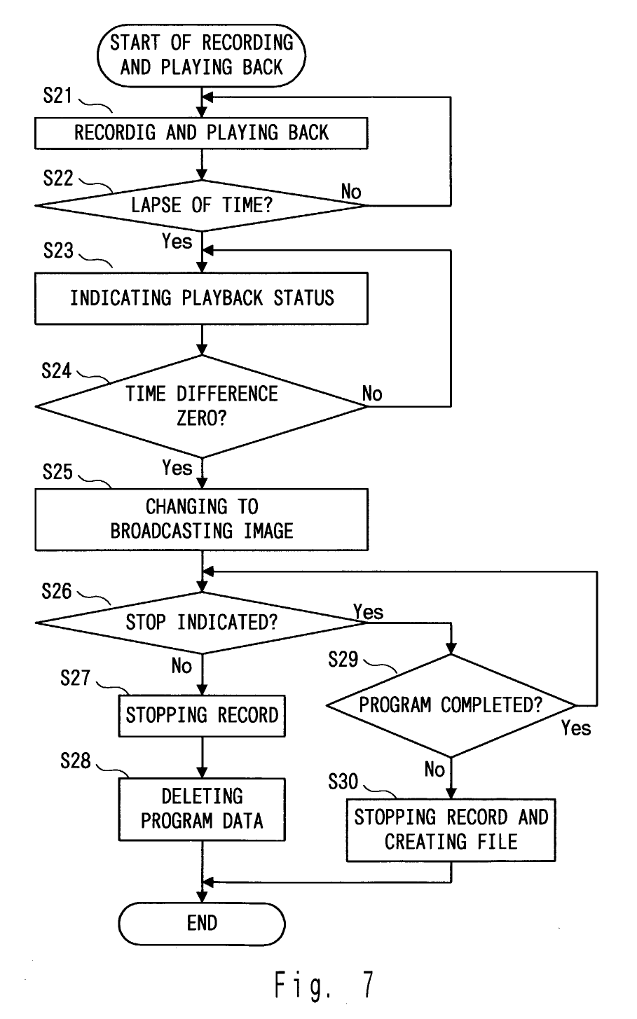

In this case, if a user plays back a broadcasting program and views it that was recorded several minutes before, it could happen that playing back is caught up with recording when CM cut or fast playing back is performed. If it happens, the playback is stopped and the playback image on the TV monitor is automatically changed to the current broadcasting image. And announcement that playing back is caught up with recording is indicated on the TV monitor along with a question asking whether the user wants to stop recording. If the record stop button is operated, recording is stopped at the time when playing back is just caught up with recording, and recorded broadcasting program is deleted from the hard disk since it has been already viewed. If the record stop button is not operated, image recorder 1 continues to record and to store the broadcasting program including the already recorded broadcasting program. The following explains specific control of the above-described process with the help of FIG. 7. FIG. 7 is a flowchart showing control of playing back while recording a broadcasting program simultaneously.

In step S21, a broadcasting program is recorded and recorded broadcasting program is played back. In step 22, it is determined whether the current playing-back image was recorded within a predetermined time. If it was so, the flow is advanced to step S23. If not, the flow is returned to step S21, and recording and playing back is continued. In step S23, it is indicated that playing back will soon be caught up with recording on the TV monitor. And when playing back is caught up with recording, it is asked whether recording is stopped on the TV monitor. In step S24, it is determined whether time difference between recording and playing back is zero. If the time difference is zero, then the flow is advance to step S25, if not, then the flow is returned to S25. In step S25, playing back is stopped, and an image on the TV monitor is changed from a played-back image to a broadcasting program image. In this case, although playing back is stopped, if recording is continued, it is possible that playing back is continued, and displaying an image on the TV monitor is continued. And, when the time difference between recording and playing back is zero by fast playback, the fast playback is changed to a normal playback. In step S26, it is determined whether stopping by record stop button 208 has been instructed. If it is instructed, then the flow is advanced to S27, if not, then the flow is advanced to step S29. In step S27, recording is stopped. Instep S28, the broadcasting program image data that is stored so far is deleted, and the present flow is completed. The reason for deleting the broadcasting program image data is that viewing has been completed and recording is stopped.

In step S29, it is determined whether a series of broadcasting programs ends. If a series of broadcasting programs ends, the flow is advanced to step S30. If not, recording of the broadcasting program is continued. In step S30, recording is stopped, and the recorded broadcasting program is processed so as to become one file. And the present flow is completed.

Image recorder 1 of the First Embodiment is such that broadcasting program image data is stored in built-in hard disk 16. Unlike VTR, when a user wants to delete the stored broadcasting program image data, it is necessary to instruct to delete the broadcasting program image data. Then, image recorder 1 has such a function as to indicate instruction to prompt the user to delete the broadcasting program image data as follows.

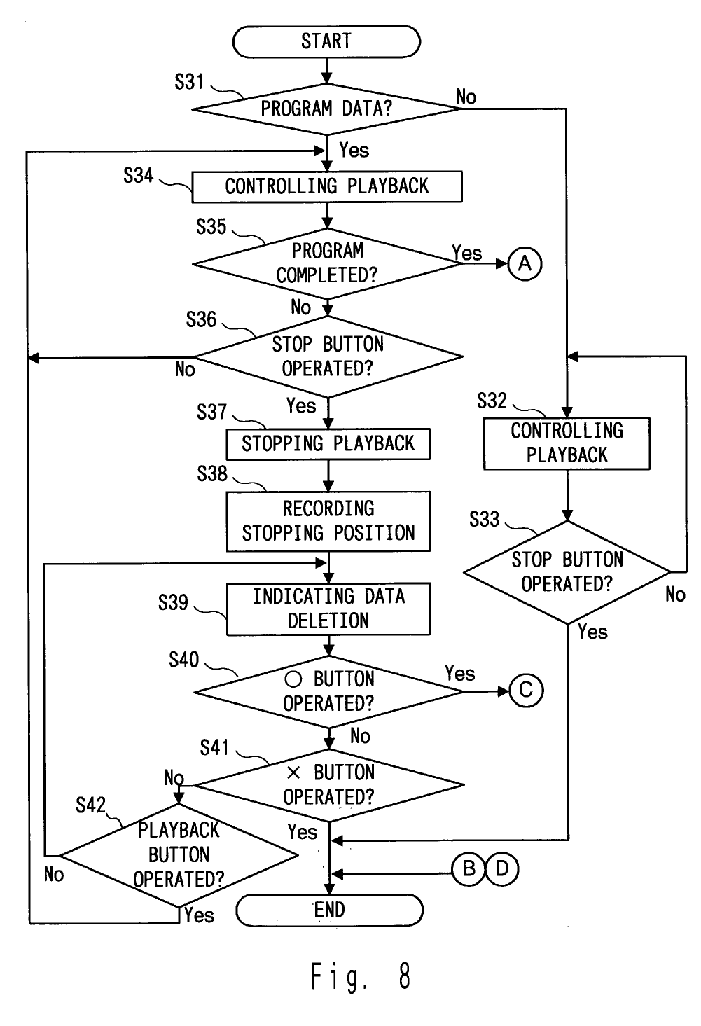

Image recorder 1 has such a function that it stops automatically when a user views recorded broadcasting program image data to the last, and asks whether deletion (overwrite) of the data is acceptable. Image recorder 1 also has such a function that it asks whether a user holds or deletes the whole storage of the broadcasting program image data, or deletes viewed part. In case of deleting viewed part, a file containing the data other than the viewed part is created. At this time, thumbnail images for a listing are not modified and kept in an original set. The following makes a specific explanation of controlling the above-mentioned functions with the help of FIGS. 8 to 10. FIGS. 8 to 10 are flowcharts showing control of playing back recorded data.

The present flow is started by selecting broadcasting program image data or other data, and pressing playback button 204.

As shown in FIG. 8, in step S31, it is determined whether data to be recorded is broadcasting program image data. If the data is broadcasting program image data, then the flow is advanced to step S34. If not, the flow is advanced to step S32. In step S32, selected image data is played back. In step S33, it is determined whether playback button 205 has been operated. If playback button 205 has been operated, then the present flow is completed. If playback button 205 has not been operated, the flow is returned to step S32, and playing back is continued. In this case, control of prompting a user to delete broadcasting program image data is not performed.

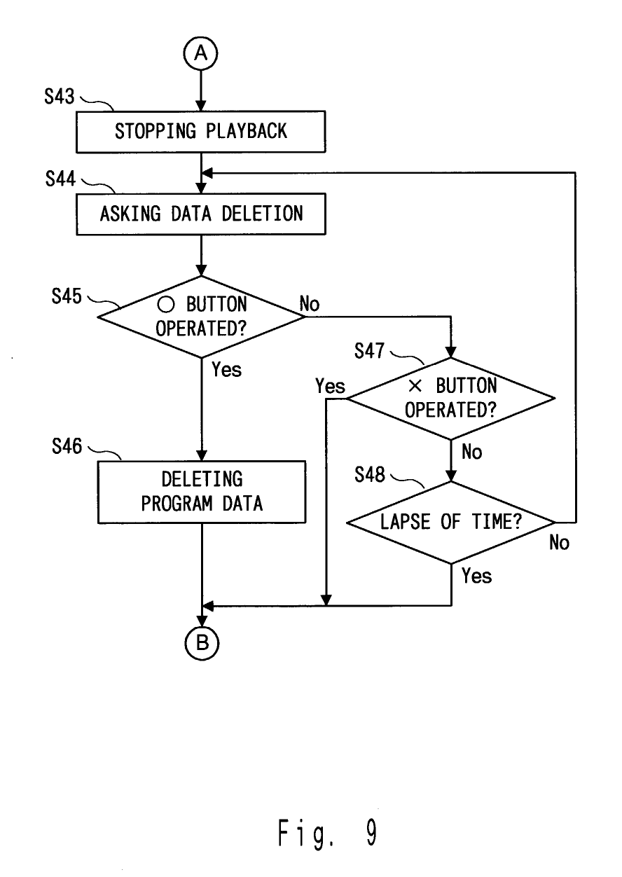

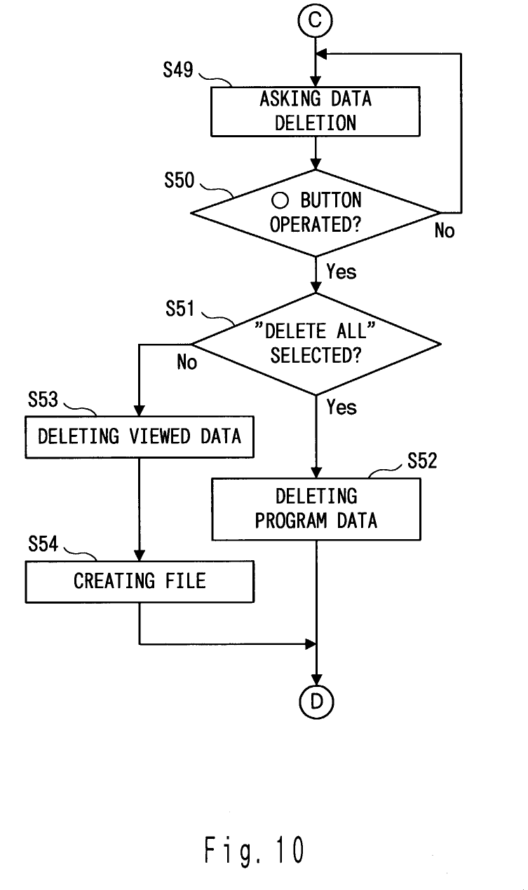

In step S34, compressed broadcasting program image data is recovered and played back. In step S35, it is determined whether the broadcasting program data has been played back to the last. If the broadcasting program data has been played back to the last, then the flow is advanced to step S43 as shown in FIG. 9 If not, then the flow is advanced to step S36. In step S36, it is determined whether playback stop button 205 has been operated. If the button has been operated, then the flow is advanced to step S37. If not, then the flow is returned to step S34, and playing back is continued. In step S37, playing back broadcasting program image data is stopped. In step S38, position information where image recorder 1 is stopped is stored. When image recorder 1 is played back next time, image recorder 1 begins to play back from the stopped point. In step S39, a question whether a user deletes broadcasting program image data is indicated on the TV monitor. In step S40, it is determined whether ∘ button 210 has been operated. If the button has been operated, then the flow is advanced to step S49 as shown in FIG. 10. If not, the flow is advanced to step S41. In step S41, it is determined whether X button 211 has been operated. If the button has been operated, then the present flow is completed without deleting broadcasting program image data. If the button has not been operated, the flow is advanced to step S42. In step S42, it is determined whether playback button 204 has been operated. If the button has been operated, the flow is returned to step S34, and image recorder 1 resumes playing back from a stopped point. If the button has not been operated, then the flow is returned to step S39, and image recorder 1 continues to indicate the question whether a user deletes broadcasting program image data.

In step S40, in the case of operating 0 button 210, the flow goes to step S49 in FIG. 10. In step S49, a user is asked a question on the TV monitor, whether he deletes the whole broadcasting program image data or a viewed part of the broadcasting program image data. At this time, it is possible to choose an instruction “Delete the whole broadcasting program image data” or “Delete a viewed part of the broadcasting program image data” on the TV monitor using cross button 209. In step S50, it is determined whether ∘ button 210 has been operated. If the button has been operated, the flow is advanced to step S51. If not, the flow is returned to S49. In step S51, it is determined whether the instruction “Delete the whole broadcasting program image data” has been chosen on the TV monitor when ∘ button 210 was operated in step S50. If the instruction has been chosen, then the flow is advanced to S52, and the whole broadcasting program image data is deleted, then the present flow is completed. If the instruction has not been chosen, then the flow is advanced to step S53. In step S53, since it has been chosen to delete “a viewed part of the broadcasting program image data”, the viewed part is deleted based upon the stop position recorded in step S38. In step S54, a new file is created by the remaining broadcasting program image data, and stored into hard disk 16, and then the present flow is completed

Furthermore, in step S43, following step S35 where it is determined that the broadcasting program image data has been played back to the last, image recorder 1 automatically stops playing back the broadcasting program image data. In step S44, such a question is indicated whether a user deletes the whole broadcasting program image data or a viewed part of the broadcasting program image data, on the TV monitor.

In step S45, it is determined whether ∘ button 210 has been operated. If ∘0 button 210 has been operated, then the flow is advanced to step S46. If not, the flow is advanced to step S47. In step S46, the broadcasting program image data is deleted, and the present flow is completed. In step S47, it is determined whether X button 211 has been operated. If the button has been operated, the broadcasting program image data is not deleted, and the present flow is completed. If the button has not been operated, the flow is advanced to step S48. In step S48, it is determined whether a predetermined time has passed from the time when the deletion of the broadcasting program image data was asked on the TV monitor. If a predetermined time has not passed, then the flow is returned to step S44. If a predetermined time has passed, then the present flow is completed.

For still images or motion picture images that a user transferred from his digital camera, these images usually are not deleted even if these images have been viewed once. It is possible to download the broadcasting program image data or still image data stored in a hard disk 16 to an external storage device through IEEE 1394 connector 14, or to write these data into card memory, as required. Since some broadcasting programs are prevented from being downloaded due to copyright, it is possible to classify stored files into prevented files and no-prevented files on a listing screen. Furthermore, it is also possible to display a listing screen including only still images, only broadcasting program image data, or only motion picture images, respectively.

With an image size, in the case of a broadcasting program image, there is no problem because the broadcasting program image is prepared so as meet a TV screen size. In the case of a still image, however, some still images sometime does not meet a TV screen size because a still image can be changed in size upon taking a photograph or performing image processing. In order to contain a still image within a TV monitor screen, it is necessary to change a still image size by subsampling or interpolation. For this reason, image recorder 1 has an image processing circuit for automatically changing a still image size to a specific size. Furthermore, the image processing circuit can adjust a panorama size image, which has a different aspect ration from that of TV image, so as to meet TV image size.

The following explains control of recording and playing back a still image data in accordance with the First Embodiment of the present invention. When card memory is inserted into card slot 22, image recorder 1 starts control of transferring data stored in the card memory. Unlike a personal computer, image recorder 1 limits types of using data to such image data as MPEG or JPEG image data, sound data and data such as HTML format data. Accordingly, data other than above types of data is prevented from entering into image recorder 1, thereby only desired data being stored into image recorder 1. With regard to data usability, it is determined, based upon such a thing as file type name (extension), whether data is usable in image recorder 1.

When a digital camera is connected to an IEEE terminal or a USB terminal of image recorder 1 over a connecting cable, image recorder 1 starts control of acquiring the data stored in the digital camera as well as the card memory data. During acquiring the digital camera image data, on-screen characters or letters indicating that data is being acquired are displayed.

Furthermore, in accordance with the First Embodiment of the present invention, since image recorder 1 copes with DCF and DPOF, image recorder 1 can attend data such as the number of prints to an image data file. And, the printer connected to image recorder 1 can perform control of printing according to attended data.

When a digital camera is connected to imager recorder 1, at the beginning, image recorder 1 transmits information on data treatable in image recorder 1. Receiving the information, the digital camera transmits treatable data as it is. Untreatable data such as raw data stored in independent format is transformed to data such as JPEG data, and transmitted to the image recorder 1. Thus, since data is transferred after transforming data format by communicating each other, it is more convenient. In this case, raw data corresponding to transferred data is not deleted. Furthermore, it is possible to transfer raw data along with transformed data, thereby remaining memory capacity in the digital camera being increased.

Furthermore, when a plurality of digital cameras are connected to image recorder 1, and the number of the digital cameras exceeds the upper limit capable of recording and playing back simultaneously, recording and playing back of broadcasting program image data are made prior to reading of digital camera image data. Therefore, when a user instructs image recorder 1 to record broadcasting program image data while imager recorder 1 is reading the digital camera image data, the reading is stopped on the way, and recording of the broadcasting program image data is started This allows image recorder 1 to avoid missing the broadcasting program image data. In this case, furthermore, when the reading of the digital camera image data is stopped on the way, image recorder 1 automatically resumes recording the digital camera image data when the image recorder 1 becomes a state capable of restarting record of the digital camera image data, at such a time when the broadcasting program ends or recording of the broadcasting program is paused upon a CM time. Hence, it is not necessary to instruct image recorder 1 again to record the digital camera image data.

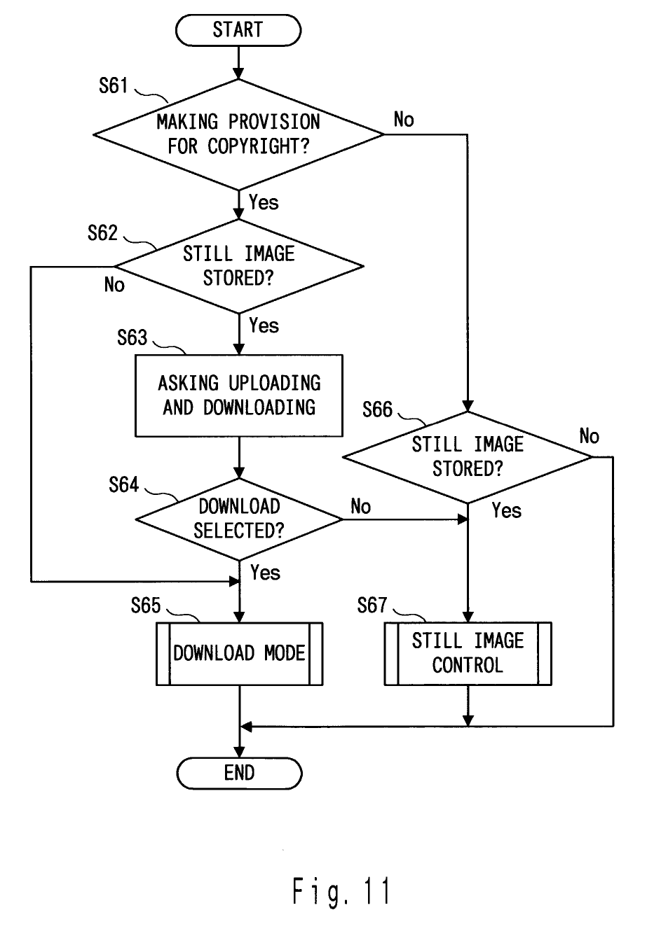

The following explains specific control of above-mentioned process with the help of FIG. 11 to FIG. 14.

When card memory is inserted into card slot 22, image recorder 1 receives thumbnails within the card memory and displays a listing of the thumbnails. When a thumbnail image is selected by cross button 209 and record button 207 of remote control 24 is operated, hard disk 16 starts copying the selected image. Image record 1 can detect the insertion of the card memory since image recorder 1 is holding a standby current during a standby state. Accordingly, it is possible to turn on the main power upon insertion of the card memory and to start control of image recorder 1. FIG. 11 is a flowchart showing control that starts detecting when the card memory is inserted into card slot 22.

Referring to FIG. 11, in step S61, it is determined whether card memory makes provision for copyright. If the card memory makes the provision for copyright, then the flow is advanced to step S62. If not, the flow is advanced to step S66. In step S62, it is determined whether the card memory stores still image data. If the card memory stores still image data, then the flow is advanced to step S63. If not, then the flow is advanced to step S65. In step S63, it is asked whether to perform downloading or uploading. Here, “downloading” means transferring data such as music data and image data into the card memory via media such as the Internet. And “uploading” means transferring data stored in the card memory to hard disk 16 of image recorder 1. In step S64, it is determined whether downloading has been selected responsive to the question in step S63. If downloading has been selected, then the flow is advanced to step S65. If not, the flow is advanced to step S67. In step S65, a mode is switched to a data receiving mode, opening a data receiving menu. The data receiving mode is such a mode that image recorder 1 is connected to the Internet and can search and download data such as desired music.

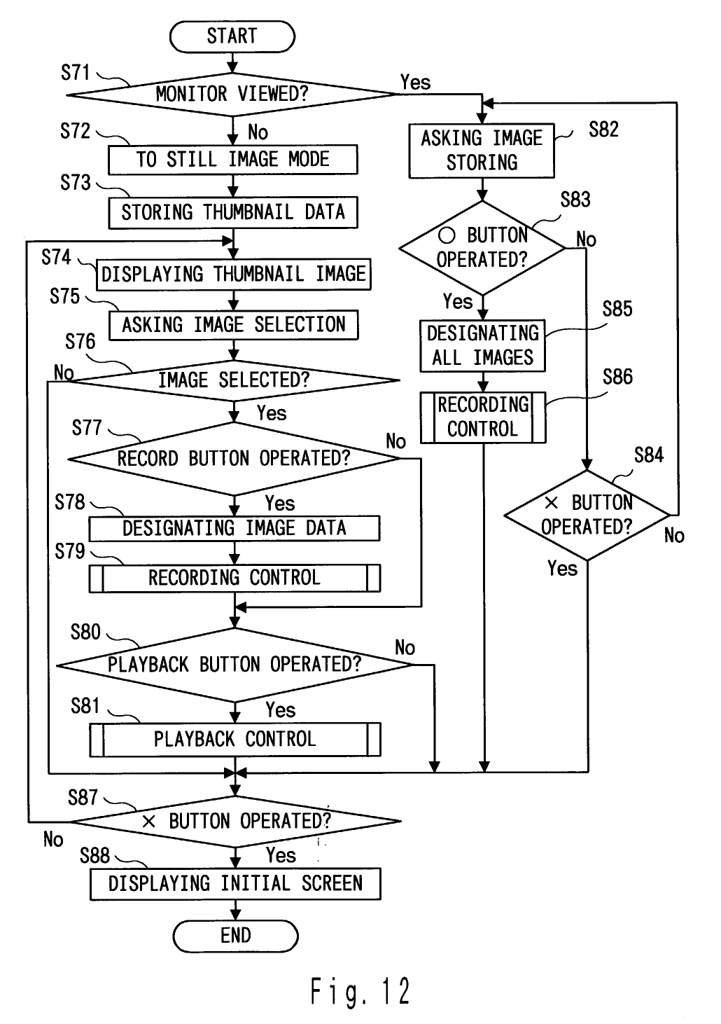

In step S66, it is determined whether the card memory contains still image data. If the card memory contains still image data, then the flow is advanced to step S67. If not, then the flow is completed without changing a screen or the mode. In step S67, image recorder 1 performs still image control of recording and playing back still images as shown in FIG. 12.

The following explains control of recording and playing back still images with the help of FIG. 12 to FIG. 14. FIG. 12 is a flowchart showing control of recording and playing back a still image.

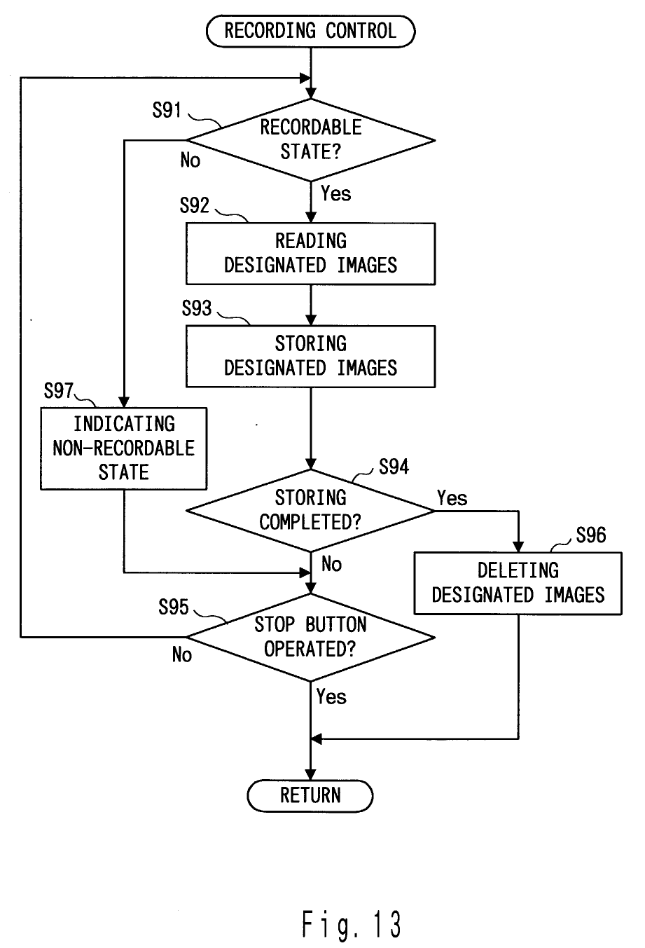

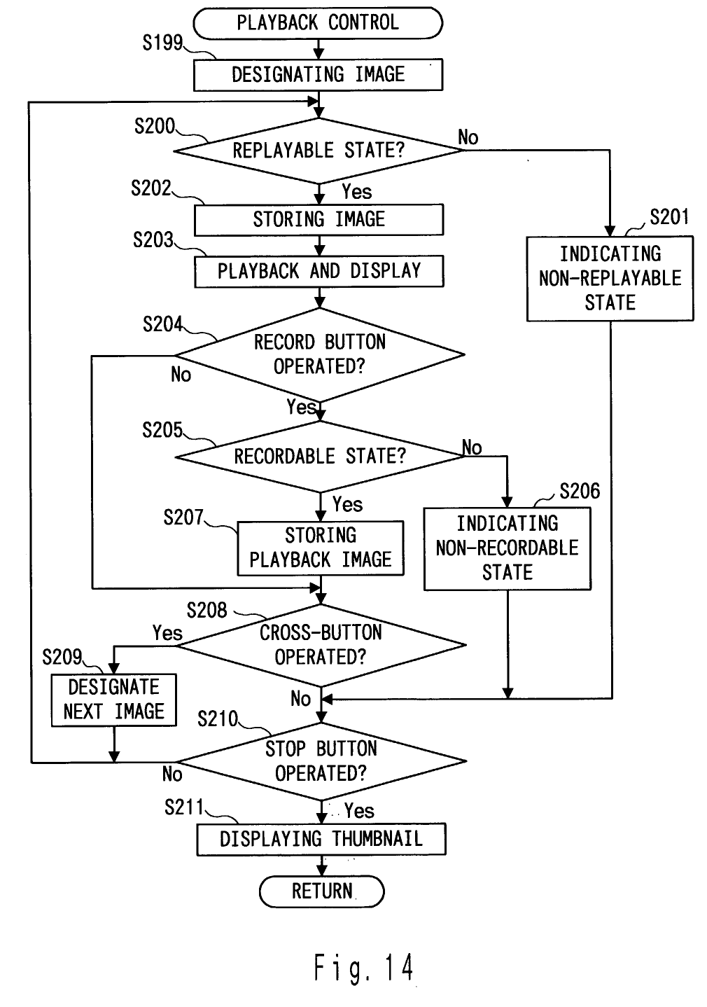

Referring to FIG. 12, in step S71, it is determined whether a user is viewing such an image as a broadcasting program image, a recorded broadcasting program image or motion picture images by detecting the current mode. If he is viewing the image, then the flow is advanced to step S 82. If not, the flow is advanced to step S72. The reason for determining whether he is viewing is that it is possible to change a TV screen if he is not viewing the screen. In step S72, a mode is changed to a still image mode. Here, the still image mode is a mode that displays a still image transferred from the digital camera. In step S73, thumbnail images are transferred from the inserted card memory. In step S74, a listing of thumbnail images is displayed on the TV screen. Instep S75, the user is asked to select one or a plurality of images in the listing of thumbnail images. The image is designated by cross button 209 and determined to select by ∘ button 210. In step S76, it is determined whether an image has been determined. If the image has been determined, then the flow is advanced to step S77. If not, then the flow is advanced to step S87. In step S77, it is determined whether record button 207 has been operated. If the button has been operated, then the flow is advanced to S78. If not, then the flow is advanced to S80. In step S78, image data corresponding to the selected image is designated as data to be acquired. In step S79, the selected image data is acquired and stored into hard disk 16. This recording control in step S79 will be explained later with the help of FIG. 13. In step S80, it is determined whether playback button 204 has been operated. If the button has been operated, then the flow is advanced to step S87. If not, then the flow is advanced to step S87. In step S81, the selected image is played back. This playback control will be explained later with the help of FIG. 14.

In step S82, following step S71 when a user is viewing the image, he is asked whether he stores all images stored in the card memory into hard disk 16. At this time, he cannot select each image stored in the card memory because these images cannot be displayed on the TV screen that is displaying other thing such as the broadcasting program. The above-mentioned question is displayed in a corner of the on-screen image such as a broadcasting program image, using characters. In step S83, it is determined whether ∘ button 210 has been operated. If the button has been operated, then the flow is advanced to step S85. If not, then the flow is advanced to step S84. In step S84, it is determined whether X button 211 has been operated. If the button has been operated, then the flow is advance to step S87. If not, then the flow is returned to step S82. At this time, if ∘ button 210 is operated, it is determined that storing all images is affirmed. If X button 211 is operated, it is determined that storing all images is denied. In step S85, all of image data stored in the card memory are designated as image data to be acquired. In step S86, recording control is performed as shown in FIG. 13. In step S87, it is determined whether X button 211 has been operated. If X button 211 has been operated, then the flow is advanced to step S88. If not, then the flow is returned to step S74. In step S88, the current still image mode is returned to the preceding mode and a screen display is changed. Then the present flow is completed.

The following explains recording control with the help of FIG. 13. FIG. 13 is a flowchart showing recording control of still image data.

Referring to FIG. 13, in step S91, it is determined whether image recorder 1 is in a recordable state. If imager recorder 1 is in a recordable state, then the flow is advanced to step S92. If not, then the flow is advanced to step S97. The present image recorder 1 can perform a plurality of recording simultaneously. For example, even if a broadcasting program is being recorded, a still image can be recorded simultaneously. However, if a plurality of broadcasting programs are being recorded simultaneously, still images sometimes cannot be recorded because a broadcasting program data is prior to still image data. In step S92, designated image data is acquired from the card memory. In step S93, acquired image data is stored into hard disk 16. At this time, this image data is stored in a manner that the image data is distinguished from the broadcasting program image data, for example, in such a manner as to store each of the image data into a different file. Instep S94, it is determined whether acquiring and recording of designated image data are completed. If they are completed, then the flow is advanced to step S96. If not, then the flow is advanced to step S95. In step S96, designated image data stored in the card memory, which has been already stored into hard disk 16, is deleted. In step S95, it is determined whether record stop button 208 has been operated. If the button has been operated, then the present flow is completed. If not, then the flow is returned to step S91, and recording control is continued.

In step S97, following step S91 when imager recorder 1 is not in a recordable state, the TV monitor indicates that recording an image is impossible at present and recording will be performed immediately when it becomes possible. In this no-recordable state, if the broadcasting program ends or a CM time begins, image recorder 1 can restart recording. At this time, image recorder 1 automatically resumes recording the digital camera image data.

The following explains playback control with the help of FIG. 14. FIG. 14 is a flowchart showing control of playing back a still image data. In this flowchart, the playback of an image data stored in card memory is performed.

Referring to FIG. 14, in step S199, the first image among selected image data is designated. In step S200, it is determined whether image recorder 1 is in a recordable state. If image recorder 1 is in the recordable state, then the flow is advanced to step S202. If not, then the flow is advanced to step S201. In step S201, it is indicated that image recorder 1 cannot play back a still image at present, and the flow is advanced to step S210. In step S202, designated image data is acquired from the card memory and stored into buffer memory temporarily. In step S203, acquired image data is played back and displayed. In step S204, it is determined whether record button 207 has been operated. If the button has been operated, then the flow is advanced to step S205. If not, then step is advanced to step S208. In step S205, it is determined whether recording is possible. If recording is possible, then the flow is advanced to S207. If not, then the flow is advanced to the step S206, and it is indicated that recording is impossible at present, and then the flow is advanced to step S210. In step S207, a still image data being played back is stored into hard disk 16. In step S208, it is determined whether cross button 209 has been operated. If the button has been operated, then the flow is advanced to step S209. If not, then the flow is advanced to step S210. In step S209, an image next to the present displayed image is designated, and the flow is returned to step S200. In step S210, it is determined whether playback stop button 205 has been operated. If the button has been operated, then the flow is advanced to step S211. If not, then the flow is returned to step S200. In step S211, the screen is returned to a thumbnail listing screen, and this flow is returned.

Thus, in accordance with the First Embodiment of the present invention, as described above, by using the record button and the playback button for both of broadcasting program image data and digital camera image data, it is not necessary to increase the number of buttons, and it is possible to record and play back conveniently.

Furthermore, in the above-mentioned case, although image data is transferred from card memory that is inserted into image recorder 1, it is also possible that image data is transferred directly from the digital camera that is connected to image recorder 1 through a cable and IEEE 1394 connector 114.

[Second Embodiment]

The following explains a Second Embodiment of an image recorder in accordance with the present invention. In the Second Embodiment, image data is not transferred from card memory but from a digital camera through a cable, wherein a docking station capable of recharging a rechargeable battery contained in the digital camera is connected across the image recorder and the digital camera. Since a structure of the Second Embodiment is approximately equal to the structure of the First Embodiment, an explanation of the structure of the Second Embodiment is omitted. It is, however, noted that the Second Embodiment is different from the First Embodiment in operation controlled by CPU 12.

The following is an explanation of digital camera 3 and docking station 2 connected to image recorder 1.

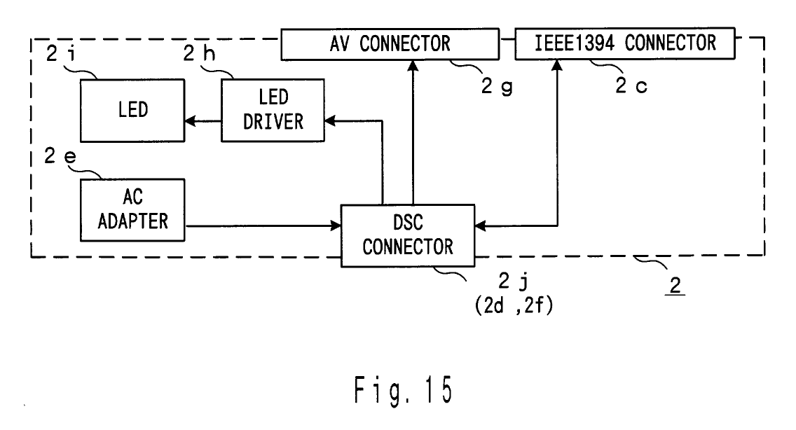

FIG. 15 represents a block diagram showing a structure of the docking station 2. Docking station 2 of the Second Embodiment is described with help of FIG. 15.

AC adapter 2e connected with commercial power source, which is not shown in the figure, is a power source in order to supply digital camera 3 mounted on docking station 2 with electric power, and is also used for charging rechargeable battery 3b of digital camera 3. DSC connector 2j is a kind of connector connected with DSC connector 3n arranged in digital camera 3 and corresponds to signal connector 2d and power supply connector 2f shown in FIG. 15. DSC connector 2j is electrically connected with AC adapter 2e and IEEE 1394 connector 2c. Signal transmission and power supply to digital camera 3 are made through DSC connector 2j. Signal connector 2d is a terminal for giving and receiving a signal in conformity with the IEEE 1394 standard. DSC connector 2j has a specific mechanical shape dedicated to digital camera 3 and also has a terminal electrically connected with AV connector 2g, which is not mentioned in FIG. 15.

AV connector 2g is for outputting the TV signal encoded with the NTSC standard by digital camera 3. Although no explanation has been made in the First Embodiment, by means of connecting AV connector 2c with an AV connector of another instrument, a TV signal encoded in digital camera 3 can be watched by the instrument having no IEEE 1394 interface.

IEEE 1394 connector 2c is a connector connected with cable 2b, which is connected with IEEE 1394 interfaces equipped in image recorder 1.

LED 2i has LED 2k for memory and LED 2m for recharging. LED 2i indicates the state of a card memory stored in digital camera 3 and the state of the rechargeable battery by its lighting condition.

LED driver 2h controls lighting of LED 2i in accordance with a command from CPU 3h of digital camera 3 or CPU 12 of image recorder 1.

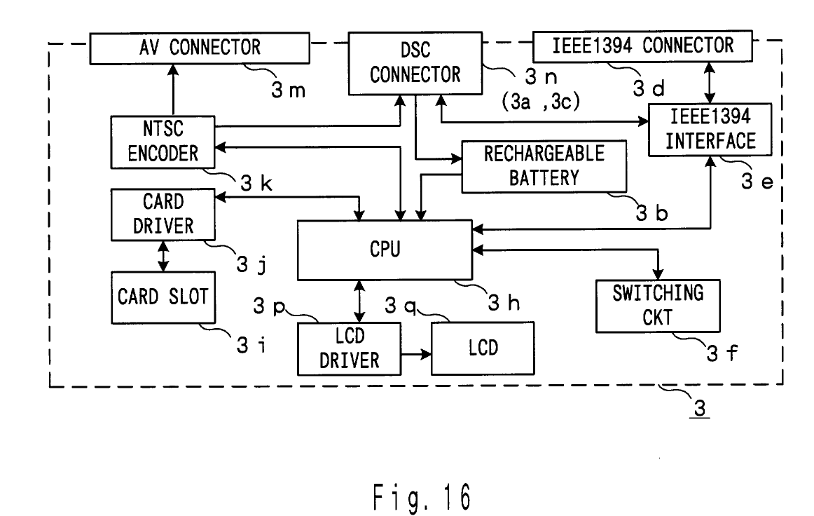

FIG. 16 represents a block diagram showing the design of digital camera 3. Digital camera 3 of the Second Embodiment is described with help of FIG. 16. Although, we omitted the explanation of picture taking and image processing, it is needless to say that the system includes photographic lens, image detector, image processing circuit, and the like.

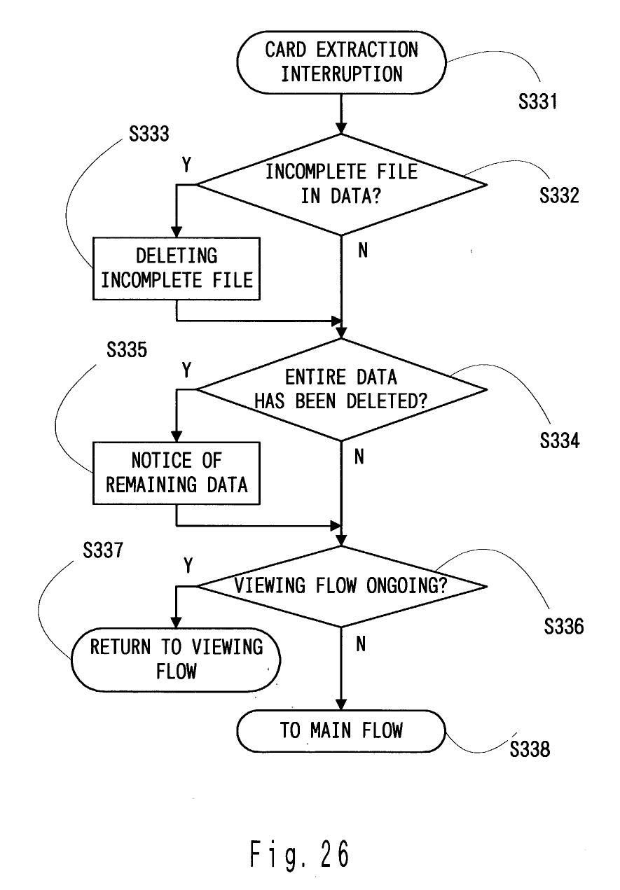

CPU 3h controls each device in digital camera 3 and performs the procedure shown in FIG. 26 mentioned later in cooperation with CPU 12 of image recorder 1. Switch circuit 3f detects whether release button 3r or command dial 3s equipped in digital camera 3 is handled or not, and transmits it to CPU 3h.

IEEE 1394 interface 3e is the device for giving and receiving control signal, image or audio signal through the IEEE 1394 interface stored in image recorder 1. IEEE 1394 connector 3d is a kind of connector for giving and receiving signal with other instruments having the IEEE 1394 interface and is used for giving and receiving signal with image recorder 1 without help of docking station 2, not mentioned in the Second Embodiment. AV connector 3m is a connector through which converted NTSC television signals are output outside. By connecting AV connector 3m to another AV connector, television signals, which are converted in digital camera 3, are observable even on devices without the IEEE 1394 interface. DSC connector 3n, through which power and signals are transferred, is connected to DSC connector 2j. DSC connector 3n includes the signal connectors, the power supply connectors, and AV terminals, as well as DSC connector 2j. Through the signal connectors, signals designed according to the IEEE standard are transferred. DSC connector 3n has a structure only for connecting to docking station 2. The rechargeable battery 3b, which supplies power to each device of digital camera 3, is recharged through AC adapter 2e of docking station 2. Card slot 3i records image signals and audio signals onto the card memory which is mounted to card slot 3i, and reads out image signals and audio signals from the card memory. Card driver 3j drives card slot 3i under instruction from CPU 3h. Image recorder 1 and digital camera 3 can be powered on under signal input from outside, in the case that image recorder 1 is not powered.

(a) Recharging an Taking in Images Flow

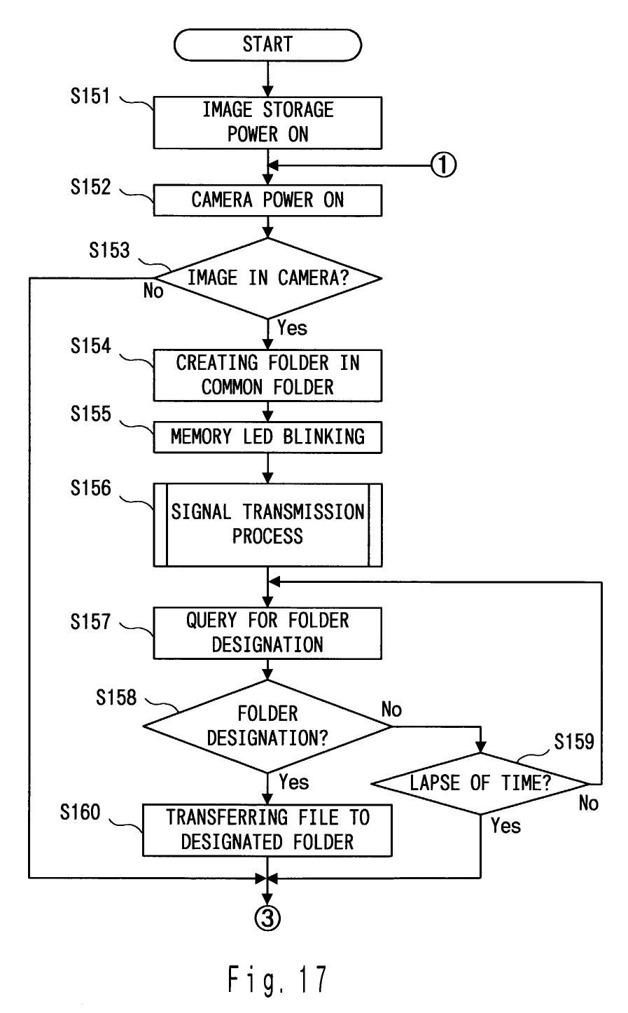

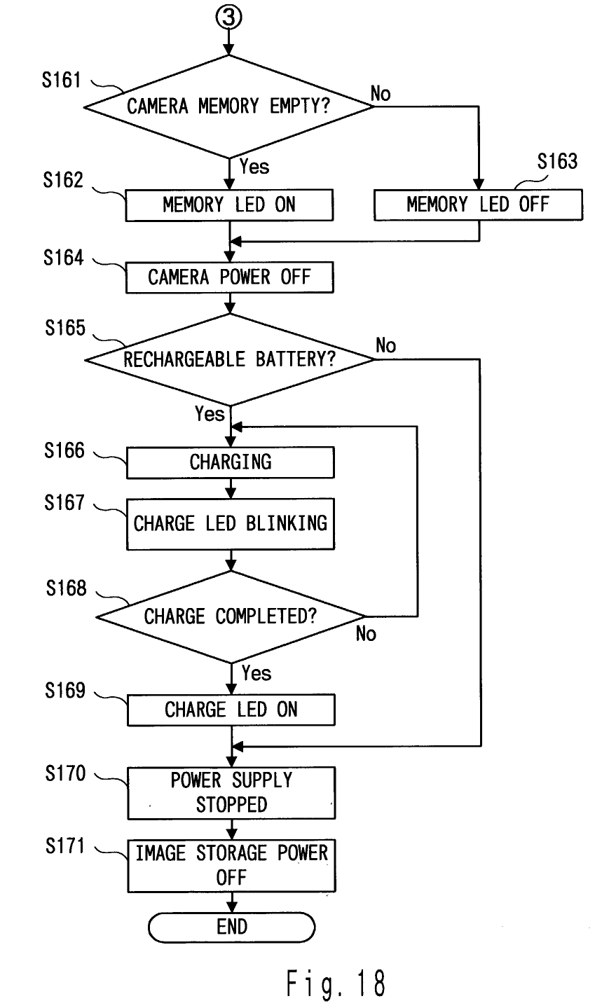

FIG. 17 and FIG. 18 are flowcharts of image transfer control executed by CPU 12 of image recorder 1. Referring to FIG. 17, a broadcasting program starts when image recorder 1 detects that digital camera 3 is connected to docking station 2. Image recorder 1 can always communicate with docking station 2 through IEEE 1394 connector 4i, cable 2b, and IEEE 1394 connector 2c, because image recorder 1 is always in the state of standing by, passing low current between docking station 2 and image recorder 1. Therefore, when digital camera 3 is connected to docking station 2, image recorder 1 can detect the connection between digital camera 3 and docking station 2.

In step S151, function necessary to receive image signals and audio signals from digital camera 3 is activated. More specifically, the main power is turned on, hard disk 16 that records image signals and audio signals is driven, and a receiving broadcasting program is activated. In step S152, AC adapter 2e of docking station 2 is operated through cable 2a, power is supplied to digital camera 3, and the main power source of digital camera 3 is switched on. In the case that the main power source of digital camera 3 is already switched on, the main power source remains being on. In step S153, it is detected whether digital camera 3 has image files or audio files that are reproducible by image recorder 1. If digital camera 3 has them, broadcasting program proceeds to step S154. If digital camera 3 does not have them, broadcasting program proceeds to step S161 in FIG. 18. Image recorder 1 is already set so that JPEG file, MPEG file, GIF file, bitmap file, and WAVE file can be reproduced. Although some digital camera has a proprietary format image, such proprietary image is reproduced only by dedicated software. Furthermore, card memories mounted to digital camera 3 may be used for other devices, therefore, other files except for image files or audio files, e.g., document files, may be mounted to digital camera 3. However, image recorder 1 is designed so that image recorder 1 does not receive files which can not be reproduced by image recorder 1.

If, provided the card memory is loadable to digital camera 3, the camera is not loaded with a card memory, it is naturally interpreted that no file exists. If digital camera 3 is not loaded with a card memory, digital camera 3 is controlled so that LCD 3q of digital camera 3 presents an alarm display that reports to a user that no card memory exists. Further, if there exists an unhandleable file, digital camera 3 is controlled so that LCD 3q of digital camera 3 presents an alarm display that reports to a user that there exists an unhandleable file.

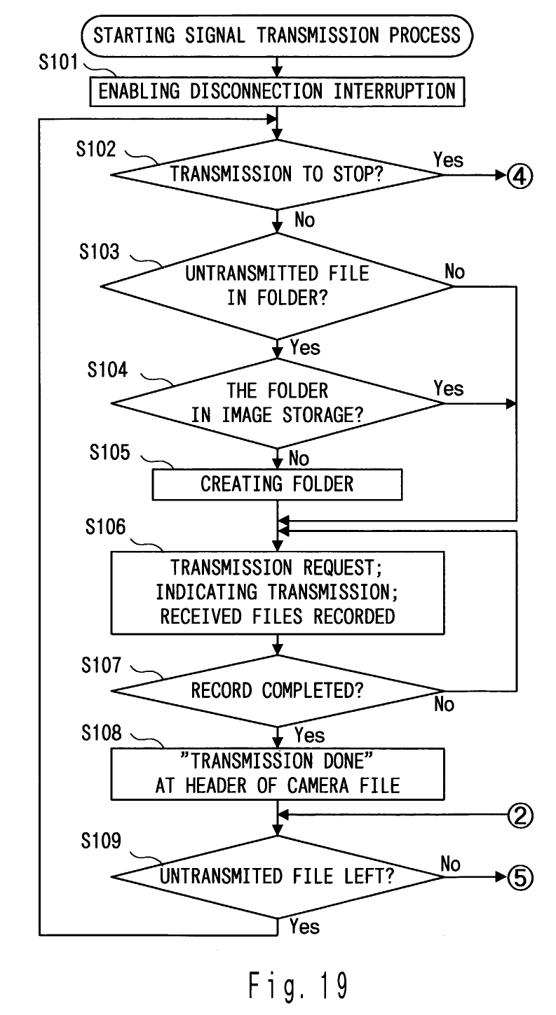

At step S154, a folder to which a folder name, e.g., date, is attached, is created in a common folder in hard disk 16. The folder is named, e.g., “990401-990402” so that it specifies the initial and last date when the image or audio signal was recorded. The date information is taken from the date information recorded in the header of the image or audio file. The common folder is a folder which is pre-created in hard disk 16 and to which files are transferred from digital camera 3. The files named “Family”, “Father”, “Mother”, and “Taro” are also pre-created in a common folder of image recorder 1. At step S155, by blinking memory indicator LED 2k in docking station 2, a user is informed that a file is being transferred. At step S156, the image or audio files from digital camera 3 are received in photographing or sound recording order, and stored in the “990401-990402” folder in hard disk 16. Referring to FIG. 19, the way to control signal detection at this step is described in detail below. At step S157, such a display as shown in FIG. 11 is presented to LCD 3q of digital camera 3, and a users is asked in what folder the file is to be stored. The display presents selectable folders present in the common folder. By revolving command dial 3s, a folder is chosen, and, by pressing release button 3r, the folder chosen is indicated. At step S158, whether or not a folder has been chosen is detected. If detected, then step 160 is followed; if not detected, step 159 is followed. At step S159, whether or not a predetermined time has passed from the beginning of the inquiry into what folder is to be chosen is detected. If the predetermined time has passed, step 161 in FIG. 18 is followed, if not, step 157 is recommenced and the inquiry into what folder is to be chosen is resumed. At step S160, the folder “990401-990402” in the common folder is, wholly and without change of its folder structure, transferred to the designated (chosen) folder. At step S161, whether or not the card memory loaded in digital camera 3 is written is detected. If unwritten, step S162 is followed; if written, step S163 is followed. At step S162, by lighting memory indicator LED 2k in docking station 2, a user is informed that the card memory loaded in digital camera 3 is unwritten.

At step S163, by lighting out memory indicator LED 2k in docking station 2, a user is informed that the card memory loaded in digital camera 3 is written. At step S164, the main power supply with digital camera 3 is switched off. Even when the main power supply with digital camera 3 had been switched on at the point of connection, the main power supply of digital camera 3 is switched off at this step. At step S165, whether or not rechargeable battery 3b is loaded in digital camera 3 is detected. If loaded, step 166 is followed; if the loaded thing is not rechargeable battery 3b or rechargeable battery 3b is not loaded, step 170 is followed. In step S166, the charging to rechargeable battery 3b of digital camera 3 is started. In step S167, charging indication LED (light emitting diode) 2m is intermittently energized to inform the user of the status of rechargeable battery 3b in the process of charging. In step S168, it is checked whether the charging is completed or not. If the completion of charging is detected, the flow is advanced to step S169. On the other hand, the flow returns to step S166 to continue the charging. In step S169, charging indication LED 2m is continuously energized to inform the user of the completion of the charging to rechargeable battery 3b. In step S170, the power supply to docking station 2 is terminated. In step S171, the main power switch of image recorder 1 is turned off to close the present flow.

(b) Transmission of Signals

FIGS. 19 to 21 explain the manner of controlling signal transmission in step S156 in FIG. 17.

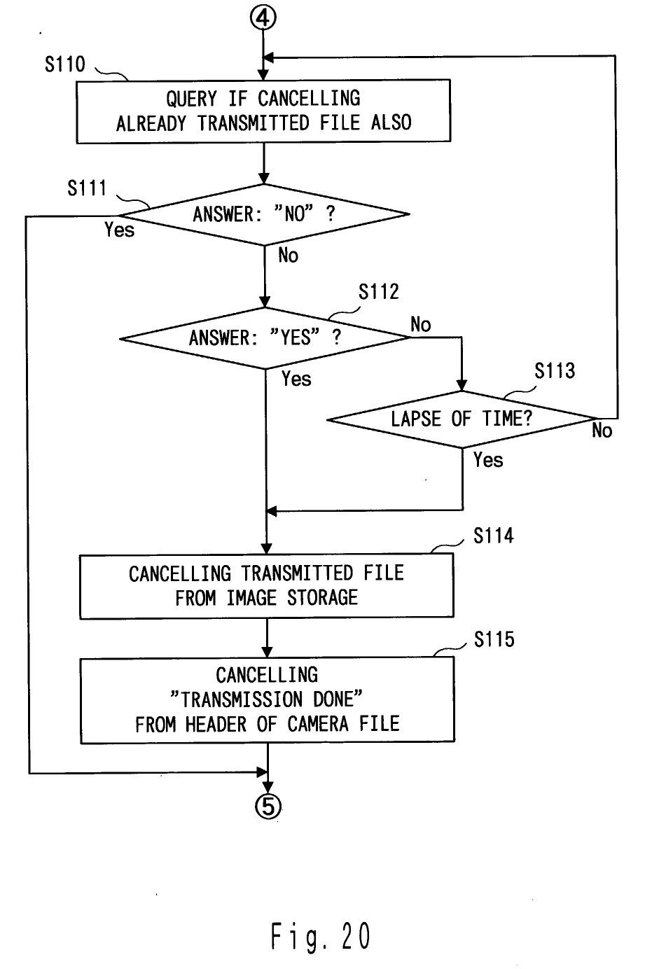

In step S101, disconnection interruption is enabled, the interruption being carried out when digital camera 3 will be disconnected from docking station 2. In step S102, it is checked whether or not digital camera 3 directs to stop the data transmission, the direction being caused by operating the release button of digital camera 3. If the date transmission is directed to stop, the flow goes to step S110 in FIG. 20. On the other hand, the flow is advanced to step S103 if the date transmission is not directed to stop. In step S103, digital camera 3 is checked for a folder (hierarchical) structure that holds files not transmitted yet. If files not transmitted yet are held in a folder structure, the flow is advanced to step S104. On the other hand, the flow is advanced to step S106 if files not transmitted yet are held without any folder structure. In step S104, it is checked whether the folder structure has already existed in the image recorder 1. If the folder structure has existed, the flow is advanced to step S106. On the other hand, the flow is advanced to step S105 if the folder structure has not existed yet. In step S105, a new folder is further created within the folder “990401-990402” which has been created in step S154 in FIG. 17.

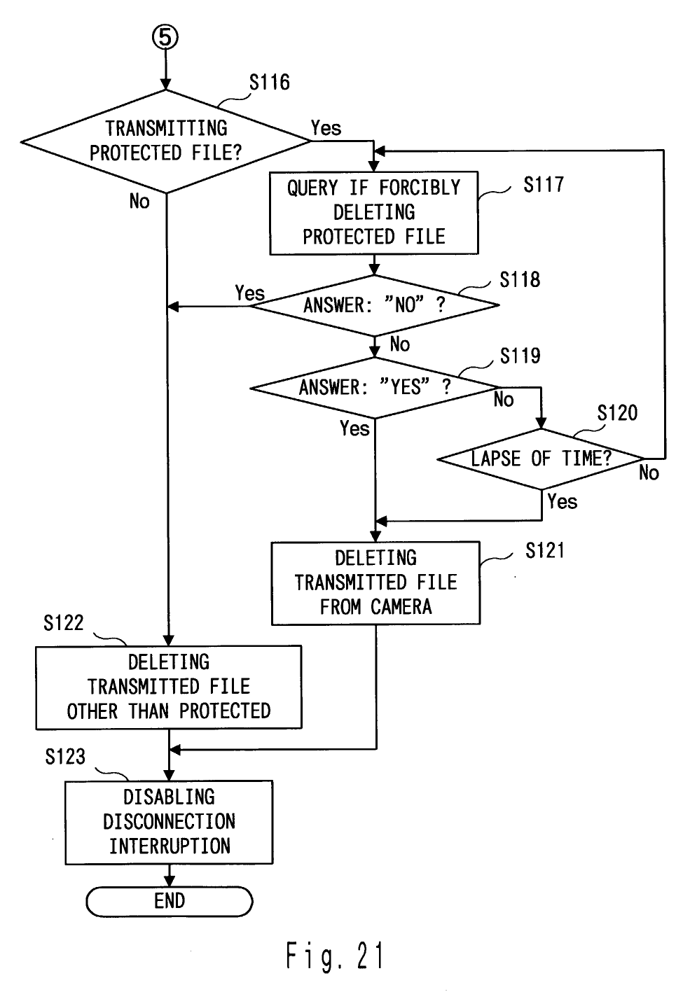

In step S106, digital camera 3 is directed to transmit new files, which are received and stored in the folder created in steps S154 and 105. Thus, the folder structure holding files in digital camera 3 will be took over by image recorder 1 without destruction of the original folder structure, which is convenient for the user to search for the stored files. Further, in step S106, digital camera 3 is directed to inform the user of the status in the process of data transmission by means of LCD 3q of digital camera 3. In step S107, it is checked whether the data transmission from digital camera 3 to image recorder 1 is completed or not. If the completion of data transmission is detected, the flow is advanced to step S108. On the other hand, the flow returns to step S106 to continue the data transmission if the completion of data transmission is not detected. In step S108, digital camera 3 is directed to add to the header of the transmitted file therein the information indicating that the transmission of the file has been completed. In steps S121 and S122 in FIG. 21, the file will be deleted from digital camera 3 in dependence on the added information. The flow is to be advanced from step S108 to step S109. In step S109, it is checked whether files capable to be treated by image recorder 1 still remain to be transmitted in digital camera 3. If files remain to be transmitted, the flow is returned to step S102. On the other hand, the flow is advanced to step S116 in FIG. 21 if no file remains to be transmitted.

If the direction to stop the data transmission is detected in the above mentioned step S102, a question at LCD 3q of digital camera 3 is made in step S110 to ask the user whether or not the transmission of all the files including already transmitted files should be cancelled. Step S111 checks the answer of the user to the question in step S110 for “No”. If the answer, “No” is detected, the flow goes to step S116. On the other hand, the flow is advanced to step S112 if the answer, “No” is not detected. The answer, “No” of the user means that the already transmitted files should not be cancelled. Step S112 checks the answer of the user to the question in step S110 for “Yes”. If the answer “Yes” is detected, the flow goes to step S114. On the other hand, the flow is advanced to step S113 if the answer “Yes” is not detected. The answer, “Yes” of the user means that the user mounts digital camera 3 on docking station 2 for the purpose of only charging the camera without data transmission. For answering the question, the use is to select “Yes” or “No” by rotating command dial 3s and press release button 3r to enter the selected answer. In step S114, the files and folder transmitted this time, and also the folder, “990401-990402” created this time are all deleted from hard disk 16 of image recorder 1. In step S115, digital camera 3 is directed to cancel the information which has been add to the header of the transmitted file to indicate that the transmission of the file has been completed.

In step S113, it is checked whether a predetermined time has passed or not after the direction to stop the data transmission. If the time has not passed yet, the flow is returned to step S110 to wait for the answer. If the time has passed, on the other hand, the flow is advanced to step S114 on the assumption that the direction to stop the data transmission at step S102 was made because user mounts digital camera 3 on docking station 2 for the purpose of only charging the camera without data transmission. In step S116, it is checked whether a protected file is transmitted or not. If a protected file is transmitted, the flow is advanced to step S117, while the flow is advanced to step S122 if a protected file is not transmitted. Digital camera 3 has a “protection” function of file management for preventing a protected file from being deleted out of the memory card in error. Ordinarily, a protected file cannot be deleted unless the protection function is cancelled. In step S117, a question is indicated on LCD 3q to ask whether the protected file is to be deleted. Step S118 checks the answer of the user to the question in step S117 for “No”. If the answer, “No” is detected, the flow goes to step S122. On the other hand, the flow is advanced to step S119 if the answer, “No” is not detected. Step S119 checks the answer of the user to the question in step S117 for “Yes”. If the answer “Yes” is detected, the flow goes to step S121. On the other hand, the flow is advanced to step S120 if the answer “Yes” is not detected. In step S120, it is checked whether a predetermined time has passed or not after the question is started to be indicated at LCD 3q to ask whether the protected file is to be deleted. If the time has not passed yet, the flow is returned to step S117 to wait for the answer. If the time has passed, on the other hand, the flow is advanced to step S121. In this design, a protected file in digital camera 3 which has been successfully transmitted to image recorder 1 is to be deleted unless an answer is especially made to the contrary, for always making use of the maximum capacity of the memory card in digital camera 3. In step S121, all the already transmitted files are deleted from digital camera 3 in response to the information add in step S108 to the header of the transmitted file. In step S122, files that have been already transmitted and are not protected are deleted from digital camera 3 in response to the information add in step S108 to the header of the transmitted file and also to the protection information. Instep S123, the disconnection interruption is disabled to close the present flow.

(c) Disconnection During Data Transmission

FIG. 20 explains the disconnection interruption. This flow starts in response to disconnecting digital camera 3 from docking station 2 with the disconnection interruption enabled.

In step S181, warning of disconnection without completing the data transmission is made at the display on digital camera 3 for recommending the user to mount the camera again. Step S182 checks whether such a file exists in hard disk 16 that the transmission thereof is unfinished by reason of the disconnection in the course of the data transmission. If such a file exists, the flow is advanced to step S183, while the flow goes to step S184 if such a file does not exist. In step S183, the file in hard disk 16 that the transmission thereof is unfinished is removed. Step S184 checks whether digital camera 3 is mounted again on the docking station 2 for the connection. If the connection is detected, the flow is advanced to step S187, while the flow goes to step S185 if the connection is not detected. Step S187 checks whether the digital camera mounted again is the same digital camera 3 or not. In the case of the same digital camera 3, the flow is advanced to step S109 in FIG. 19, while the flow goes to step S152 in FIG. 17 in the case of a different digital camera.

In step S185, it is checked whether a predetermined time has passed or not after the disconnection. If the time has passed, the flow is advanced to step S186, while the flow returns to step S184 if the time has not passed yet. In step S 186, the main power switch of image recorder 1 is turned off to close the present flow. In the above mentioned Second Embodiment, all the correctly transmitted files are deleted from digital camera 3 at once after completing the transmission of all of them. However, such a modification is possible that each file is deleted after completing the transmission of it one by one. Further, the file is actually deleted from the digital camera in the Second Embodiment. However, it is possible to merely add information of permitting the deletion to the header of the file to be deleted in place of actually deleting the file, in the case of a digital camera capable of overwriting a new file on the file to be deleted.

When image recorder 1 and digital camera 3 is connected through docking station 2, a battery within digital camera 3 is controlled to be recharged, as described above. However, when image recorder 1 and digital camera 3 is connected directly, recharging control is omitted.

[Third Embodiment]

The following explains a Third Embodiment of the present invention. An image recorder of the Third Embodiment

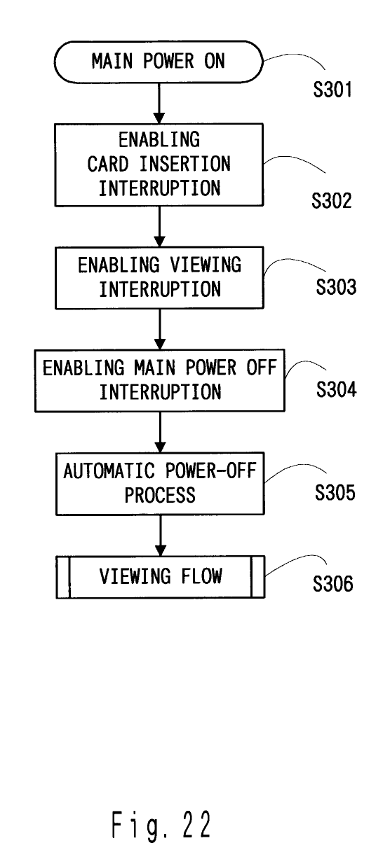

Since a structure of image recorder 1 of the Third Embodiment is approximately equal to the structure of the First Embodiment, an explanation of the structure of the Third Embodiment is omitted. It is, however, noted that the Third Embodiment is different from the First Embodiment in that image recorder 1 cannot record and play back a plurality of data simultaneously and control performed by CPU 12 is not same. Image recorder 1 of the Third Embodiment automatically starts transferring image data when card memory is inserted into card slot 22. The following explains operations of the Third Embodiment with the help of FIGS. 22 to 29.

FIG. 22 is a main flowchart showing operations of image recorder 1 of the present invention. The main flowchart starts when a main power is turned on in step S301. After a predetermined starting process is performed, the flow is advanced to step S302. In step S302, card insertion interruption becomes possible so as to cope with card insertion at any time. In step S303, viewing interruption becomes possible so as to cope with a viewing mode at any time. In step S304, main power off interruption becomes possible so as to cope with main power off. The viewing mode is a mode where still image data and broadcasting program image stored in hard disk 16 is viewed.

After above-mentioned interruption, in step S305, an automatic power-off process is performed. In the automatic power-off process, at the beginning, a timer for the automatic power-off is set and started, and the automatic power-off is executed if any operation is not performed in the set time, and then devices are automatically turned off, maintaining a standby state in which a small current is being held. In the standby state, if a predetermined operation is detected, the devices automatically turn on. After these processes, the flow is advanced to step S306, e.g. the viewing flow.

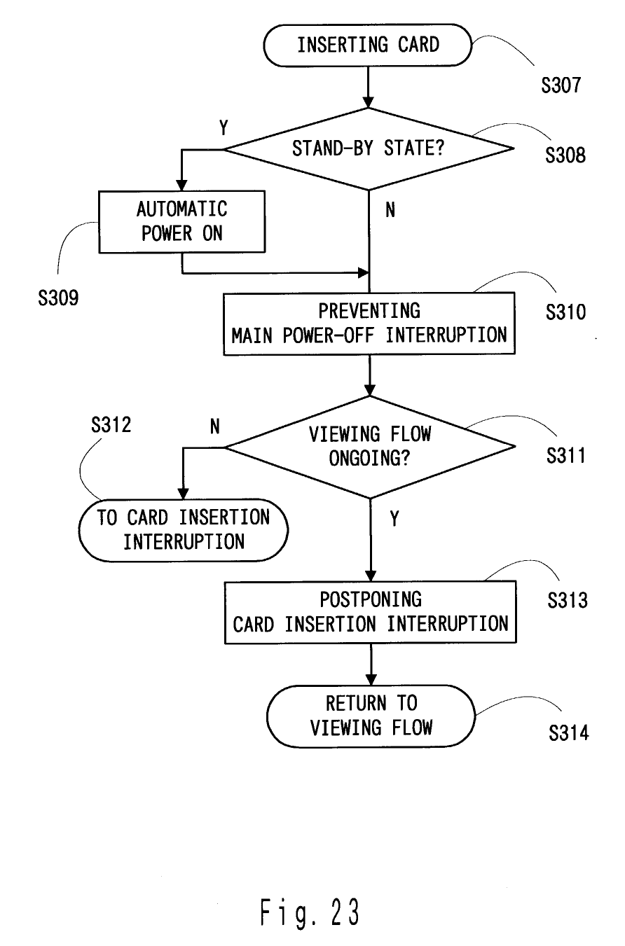

FIG. 23 shows an inserting-card-start flow. In step S307, memory card is inserted. In step S308, it is determined whether image recorder 1 is in a standby state. If image recorder 1 is in the standby state, then the flow is advanced to step S309. In step S309, image recorder 1 is automatically turned on, and the flow goes to step S310. If image recorder 1 is not in the standby state, image recorder 1 has been already turned on. Then, the flow is advanced to step S310.

In step S310, main power-off interruption is prevented. This is for avoiding the power from turning off before data stored in the card memory is transferred and deleted. The flow is advanced to step S311. In step S311, it is determined whether a viewing flow is being performed at present. If the viewing flow is not being performed, then the flow is advanced to step S312, and goes to card insertion interruption. If the viewing flow is being performed, then the flow is advanced to step S313. In step S313, card insertion interruption is postponed, and the flow is advanced to step S314, and then the flow is returned to the viewing flow. Accordingly, even if the memory card is inserted, viewing an image is not stopped. Meanwhile, since the fact that the card has been inserted is recorded, card insertion interruption is performed while viewing is not performed as described later. If card insertion interruption is performed as described later, main power-off interruption becomes possible when card insertion interruption is completed.

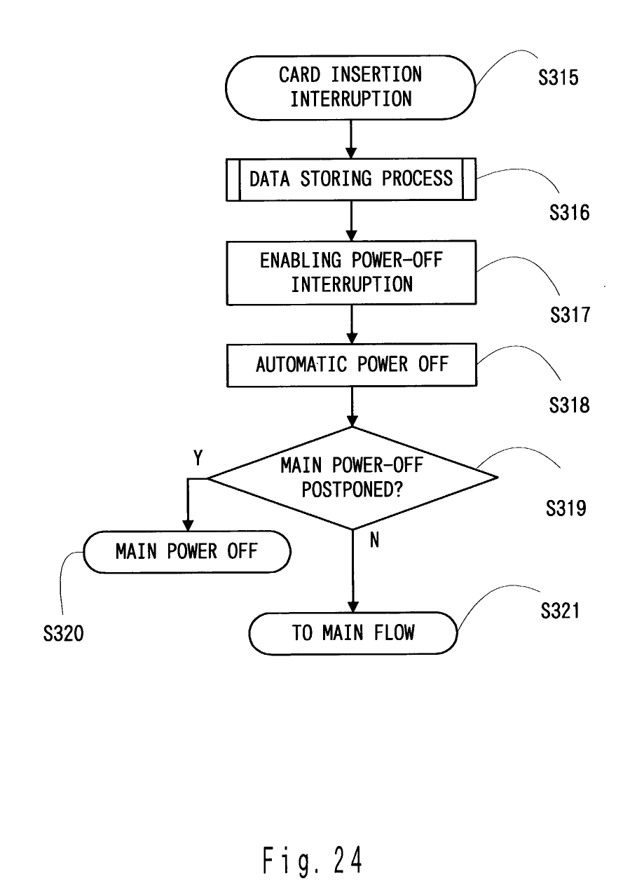

FIG. 24 is a flowchart showing card insertion interruption. In step S315, following step 312 in FIG. 23, card insertion interruption is started. In step S316, data-acquiring process is performed. After data-acquiring process is completed, the flow goes to step S317. In step S317, power-off interruption becomes possible. In step S318, automatic power off is performed. In step S319, it is determined whether a main power off process is postponed. If the main power off process is postponed, then the flow is advanced to step S320. In step S320, the main power is turned off. If the main power off process is not postponed, since the main power has not been turned off, the flow is advanced to step S321, and goes to the main flow.

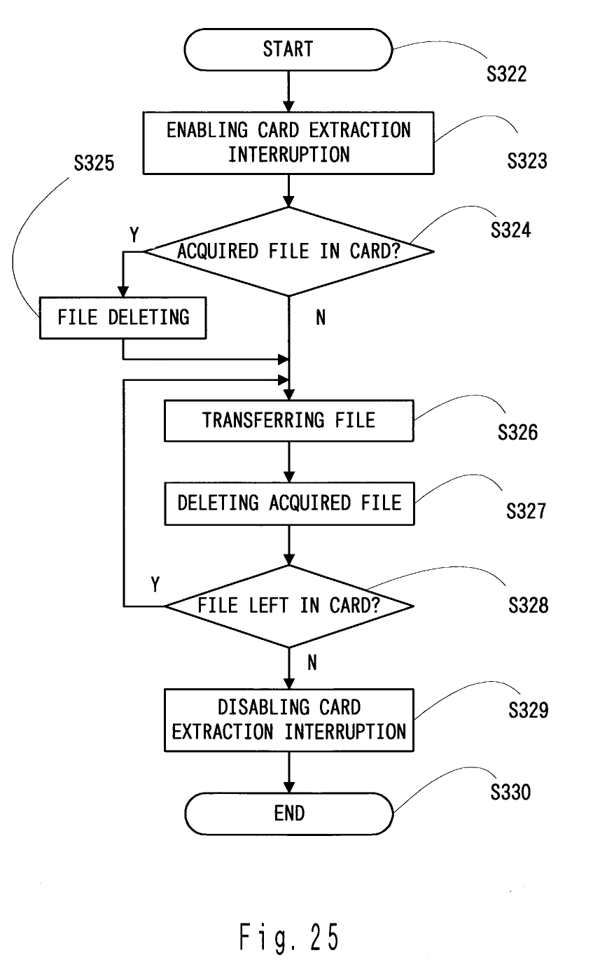

FIG. 25 is a flowchart showing a detailed process of data-acquiring process of step S316 in FIG. 24. Instep S322, data-acquiring process starts. In step S323, card extraction interruption becomes possible. This enables image recorder 1 to cope with sudden extraction of the card while data is being acquired. In step S324, it is determined whether an acquired file remains in the inserted card memory. In the case where the card is inserted again after data acquisition is stopped on the way, the acquired file could remain in the card memory even though a flag is on; the flag-on state indicates that data has been acquired. 2In such a case, the file is removed from among file items to be acquired in the card memory in step S325. In step S326, the file to be acquired is transferred into a hard disk. Each time one file is transferred to hard disk 12, a flag becomes on. In step S327, a file of which flag is on is deleted from the card memory. Each time a file has been transferred to the hard disk in step S326, the flow goes to step S327. Furthermore, instead of transferring a file at a time, such a modification is possible that all files are transferred to the hard disk at a time and then the flow is advanced to step S327. In step S328, it is determined whether the transferred file or the file to be deleted remains in the card memory. If such a file remains in the card memory, the process is returned to step S326. If such a file does not remain in the card memory, the flow is advanced to step S329, and card extraction interruption is made impossible. In step S330, the data acquiring flow is completed.

FIG. 26 is a flowchart showing card extraction interruption. In step S331, card extraction interruption is performed when the card is extracted carelessly during transferring data to a hard disk. In step S332, it is determined whether incompletely stored file exists in hard disk 12 as a result of extraction of the card during storing data. If incompletely stored file exists, then the flow is advanced to step S333. Instep S333, the incompletely stored file is removed from the data stored in the hard disk. Since an original data exists in the card, it is possible to store the data again by inserting the card. In step S334, it is determined whether entire data to be acquired has been transferred to the hard disk and deleted from the card memory. Since data that manages the data to be acquired is stored to the hard disk when the card is inserted, the determination in step S334 is possible by comparing the managing data and a history of data deletion. And if data to be acquired remains in the card memory, then the flow is advanced to step S335. In step S335, it is noticed that data to be acquired remains in the card memory. And a user is prompted to insert the card memory again.

Then, the flow is advanced to step S336. In step S336, it is determined whether viewing flow is currently being performed. If viewing flow is being performed, then the flow is advanced to step S337, and returned to the viewing flow. In this case, it is meant that the card memory has been extracted during viewing images. If the viewing flow is not being performed, then the flow is advanced to step S338, and returned to the main flow.

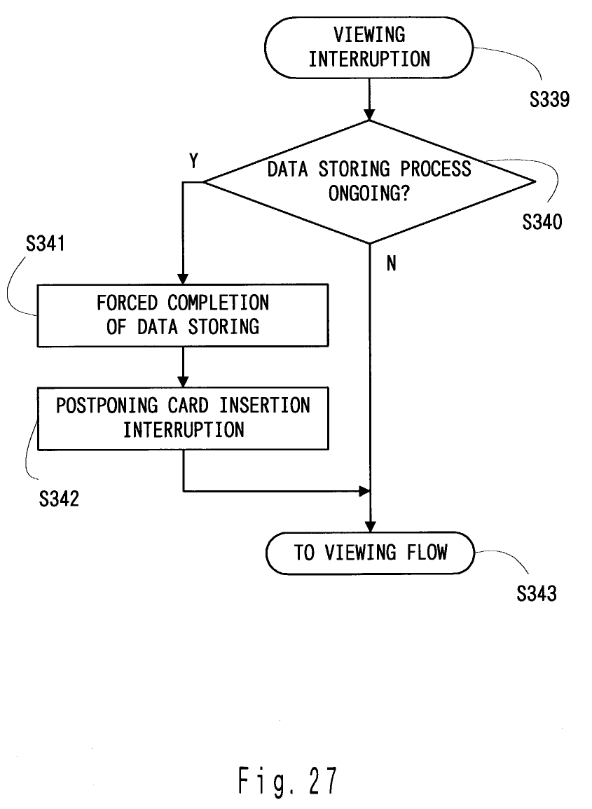

FIG. 27 is a flowchart showing viewing interruption. In step S339, viewing interruption is performed. In step S340, it is determined whether data is being stored. If data is being stored, then flow is advanced to step S341. In step S341, data storing is completed forcefully. By doing this, user's desire of viewing an image is made prior to a process of data storing, it is not necessary for a user to wait until completion of data storing. In step S342, card insertion postponement interruption is performed so as to resume storing data after completion of viewing. In step S343, the flow goes to the viewing flow. If data is not being stored in step S340, then the flow is directly advanced step S343 and goes to the viewing flow.

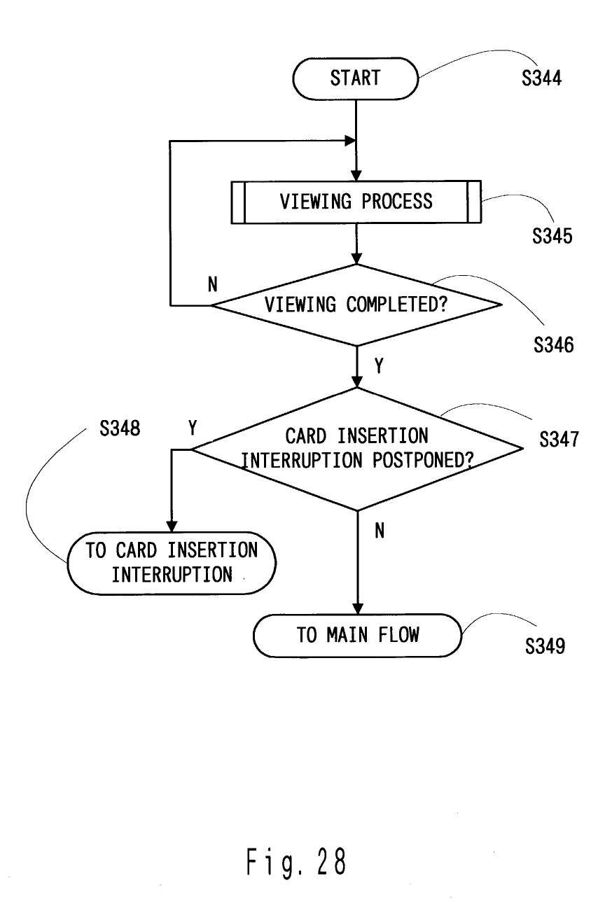

FIG. 28 is a flowchart showing viewing flow. In step S344, the viewing flow is started. In step S345, viewing process is performed. In step S346, it is determined whether viewing images is completed. If viewing images is not completed, then the flow is returned to step S345. If viewing images is completed, then the flow is advanced to step S347. Instep S347, it is determined whether card insertion interruption is postponed. If card insertion interruption is postponed, then the flow is advanced to step S348. In step S348, the flow goes to the card insertion interruption, and data transferring is resumed. If the card insertion interruption is not postponed, the flow is advanced to step S349, and returned to the main flow.

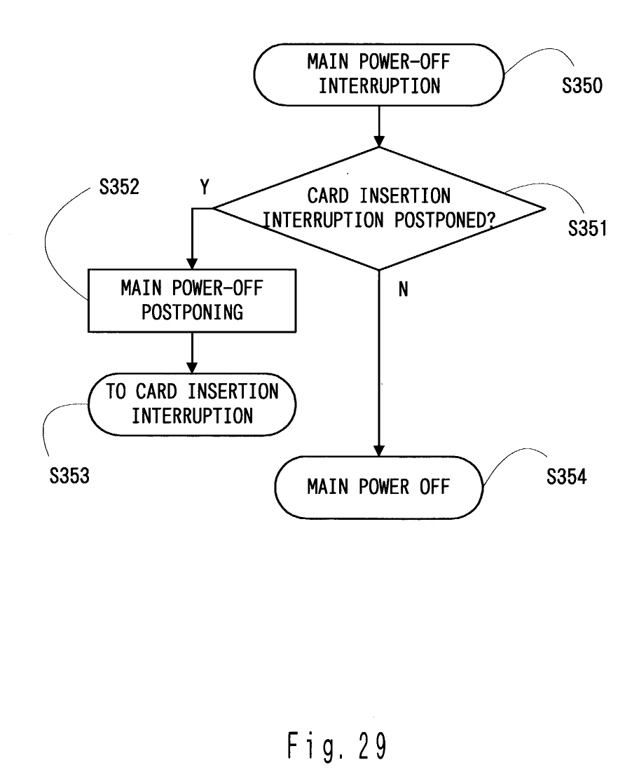

FIG. 29 is a flowchart showing main-power-off interruption. In step S350, main power is turned off when the main power is switched off. In step S351, it is determined whether the card insertion interruption is postponed. If the card insertion interruption is postponed, then the flow is advanced to step S352. In step S352, the main-power-off switching is postponed. In step S353, the flow goes to the card insertion interruption, thereby avoiding turning off the main power and transferring still image data even though the card is inserted.

In step S351, it is determined whether the card insertion interruption is postponed. If the card insertion interruption is not postponed, the main power is turned off.

Furthermore, in the Third Embodiment of the image recorder, the image recorder is made so that transferring image from the card memory is postponed in a viewing mode. However, in particular, when a still image is viewed, if all image data to be viewed is transferred from hard disk 16, it is possible to transfer the data stored in the card memory into hard disk 16 even if a user is viewing an image. Thus, by transferring image data to be viewed to hard disk 16 prior to other image data, and transforming other data to hard disk 16 later while viewing images, image recorder 1 can be operated effectively.

Furthermore, in the Third Embodiment of the present invention, operations are controlled so as that after still image data stored in the card memory has been automatically transferred into hard disk 16, the still images is deleted from the card memory. However, some card memory has a protect switch for avoiding error deletion, and image recorder 1 does not delete image data stored in this type of a card memory. In this case, image recorder 1 indicates to a user that still images exist in the card memory and how much the remaining memory is, and announces an alert that the user cannot take full picture frames allowed to the camera.

Although three embodiments of the present invention have been shown and described, it will be appreciated by those skilled in the art that changes may be made in these embodiments without departing from the principles and spirit of the invention, the scope of which is defined in the claims and their equivalents.

What is claimed is:

1. An image recorder comprising:
a storage that stores data of a visual broadcast program;
a playback that plays back the visual broadcast program on the basis of the data stored in the storage; and
a questioner that makes a question of whether or not the data of the visual broadcast program is to be automatically deleted from the storage after the playback of the visual broadcast program is terminated.

2. The image recorder according to claim 1 wherein the storage includes a randomly accessible recording medium.

3. The image recorder according to claim 1 wherein the storage includes a hard disc built in the image recorder.

4. The image recorder according to claim 1 wherein the questioner is designed to make a question of whether or not a partial data of the visual broadcast program that has been played back is to be automatically deleted from the storage if the playback of the visual broadcast program is terminated at the middle.

5. The image recorder according to claim 1 wherein the questioner is designed to make a question of whether or not the data of the entire visual broadcast program is to be automatically deleted from the storage even if the playback of the visual broadcast program is terminated at the middle.

6. The image recorder according to claim 1 wherein the questioner is designed to make the question only on a broadcast program on which the question has not been made yet.

7. The image recorder according to claim 6 wherein the questioner is designed to make the question only on a broadcast program that has been completely played back.

8. The image recorder according to claim 1 wherein the questioner is designed to make the question on a broadcast program the playback of which is terminated at the middle even if the question has already been made on the broadcast program.

9. The image recorder according to claim 1 wherein the storage is capable of storing another kind of image data than the visual broadcast program, and wherein the questioner is responsive to the kind of the played back image data to make the question.

10. The image recorder according to claim 9 wherein the other kind of image data is of an image taken by a digital camera.

11. The image recorder according to claim 9 wherein the questioner is designed not to make the question on the other kind of image data even if the playback of the image data is terminated.

12. An image recorder comprising:
a receiver that receives broadcast data including a visual broadcast program and additional date relating to the visual broadcast program and;
a storage that stores the visual broadcast program and the additional data separately from the visual broadcast program so that the relationship between the visual broadcast program and the additional data is retrieval.

13. The image recorder according to claim 12, further comprising a recording controller that puts an index on at least one of the visual broadcast program and the additional data for indicating the relationship to the other.

14. The image recorder according to claim 12 further comprising a playback that plays back the visual broadcast program and the additional data relating to the visual broadcast program on the basis of the broadcast data stored in the storage.

15. The image recorder according to claim 12, wherein the additional data includes a homepage address of the Internet relating to the visual broadcast program.

16. The image recorder according to claim 12 wherein the storage includes a randomly accessible recording medium.

17. The image recorder according to claim 16 wherein the storage includes a hard disc built in the image recorder.

18. An image recorder comprising:
a receiver that receives data of a plurality of visual broadcast programs at once;
a storage that stores the data of visual broadcast programs;
a selector that selects at least one of the visual broadcast programs; and
a recording controller that interrupts the storage of the data of the selected visual broadcast program with the storage of the data of at least another visual broadcast program continued.

19. The image recorder according to claim 18 further comprising an output circuit that outputs at least one of the received visual broadcast programs to monitor the contents thereof for the purpose of the selection by the selector.

20. The image recorder according to claim 19 further comprising a playback that plays back the visual broadcast program on the basis of the data stored in the storage, wherein the output circuit to give priority to out putting the visual broadcast program played back by playback over out putting the visual broadcast program selected by the selector, while playing back the visual broadcast program by the playback.

21. The image recorder according to claim 18 further comprising a manually operable member that causes the recording controller to interrupt the storage of the selected visual broadcast program.

22. The image recorder according to claim 21 further comprising a remote controller, wherein the manually operable member is arranged at the remote controller.

23. The image recorder according to claim 21 further comprising a display device that displays a information related to the visual broadcast program selected by the selector.

24. An image recorder comprising:
a receiver that receives data of a plurality of visual broadcast programs at once;
a first selector that selects a set of visual broadcast programs among the received visual broadcast programs;
a storage that stores the visual broadcast programs selected by the first selector;
a second selector that selects at least one of the visual broadcast programs among the set of visual broadcast programs selected by the first selector for monitoring the visual broadcast program selected by the second selector.

25. The image recorder according to claim 24 further comprising:
an output circuit that outputs a signal for monitoring the visual broadcast program; and
a playback that plays back the visual broadcast program on the basis of the data stored in the storage,
wherein the output circuit gives priority to the visual broadcast program played back by the playback over the visual broadcast program selected by the second selector.

26. An image recorder comprising:
a storage that stores data of a plurality of visual broadcast programs;
a playback that plays back the visual broadcast program on the basis of the data stored in the storage;
a selector that selects a visual broadcast program to be played back;
a first controller that controls the start and stop of the playback of a first visual broadcast program, the first controller stopping the playback of the first visual broadcast program in response to the selector selecting the second visual broadcast program; and
a second controller that controls the start and stop of the playback of a second visual broadcast program, the second controller starting the playback of the second visual broadcast program in response to the selector selecting the second visual broadcast program.

27. The image recorder according to claim 26 further comprising a mode changer between a first mode of monitoring a single visual broadcast program and a second mode of monitoring a plurality of visual broadcast program at once, wherein the first controller is responsive to the selector selecting the second broadcast program only in the first mode for continuing the playback of the first visual broadcast program even if the selector selects the second visual broadcast program in the second mode.

28. An image recorder comprising:
a storage that stores data of visual broadcast programs;
a controller that starts a playback of a visual broadcast program on the basis of the data stored in the storage in the course of storing another visual broadcast program into the storage;
a first manually operable member that stops the playback on the basis of the data stored in the storage; and
a second manually operable member that stops the storage of data into the storage.

29. The image recorder according to claim 28 further comprising a third manually operable member that starts the storage of data into the storage, wherein the second manually operable member is arranged closer to the third manually operable member than to the first manually operable member.

30. The image recorder according to claim 28 further comprising a third manually operable member that starts the playback on the basis of data stored in the storage, wherein the first manually operable member is arranged closer to the third manually operable member than to the second manually operable member.

31. An image recorder comprising:
a storage that stores data of a visual broadcast program;
a playback that plays back the visual broadcast program on the basis of the data stored in the storage;
a first controller that intermits the playback; and
a second controller that restarts the playback at a scene that is located by returning for a while from the scene of the intermission.

32. The image recorder according to claim 31 further comprising a timer that measures the lapse of time from the intermission, wherein the second controller restarts the playback without the return of the scene if the lapse of the time is less than a predetermined period.

33. An image recorder comprising:
a receiver that receives a plurality of visual broadcast programs;
a selector that selects one of the visual broadcast programs; and
an aid that facilitates the selection so that visual broadcast programs that have been selected with higher frequency are presented with easier accessibility for the selection.

34. The image recorder according to claim 33, wherein the aid includes a list in which the visual broadcast programs that have been selected with higher frequency are shown with higher priority.

35. The image recorder according to claim 33, wherein the aid is designed to automatically change the visual broadcast programs in response to the current time.

36. An image recorder comprising:
a first receiver that receives data of a visual broadcast program;
a second receiver that receives a digital image data taken by a digital camera;
a storage capable of storing both the data of visual broadcast program and the digital image data;
a recording circuit capable of recording both the data of visual broadcast program and the digital image data into the storage; and
a controller that controls the recording circuit to give priority to the data of visual broadcast program over the digital image data.

37. The image recorder according to claim 36, wherein the digital image data is a digital still image taken by a digital still camera.

38. The image recorder according to claim 36, wherein the controller is designed to control the recording circuit to postpone the recording of the digital image data until the recording of the visual broadcast program is closed.

39. The image recorder according to claim 36 wherein the controller is designed to control the recording circuit to record the digital image data with the data of visual broadcast program being recorded at the same time, if available.

40. An image recorder comprising:
a first receiver that receives data of a visual broadcast program;
a second receiver that receives a digital still image data taken by a digital still camera;
a storage capable of storing both the data of visual broadcast program and the digital still image data; and
a recording circuit that records the digital still image data into the storage so as to be distinguishable from the data of visual broadcast program upon accessing the data in the storage.

41. The image recorder according to claim 40 wherein the second receiver includes a memory slot into which a removable memory coming from the digital still camera is capable of being inserted.

42. The image recorder according to claim 40 further comprising a controller that controls the recording circuit to record the digital image data with the data of visual broadcast program being recorded at the same time.

43. An image recorder comprising:
a first receiver that receives data of a visual broadcast program;
a second receiver that receives a digital image data taken by a digital camera;
a storage capable of storing both the data of visual broadcast program and the digital image data;
a recording circuit capable of recording both the data of visual broadcast program and the digital image data into the storage; and
a controller that controls the recording circuit to record the digital image data with the data of visual broadcast program being recorded at the same time.

44. An image recorder comprising:
a first receiver that receives data of a visual broadcast program;
a second receiver that receives a digital image data taken by a digital camera;
a storage that stores both the data of visual broadcast program and the digital image data;
a playback that plays back the data in the storage; and
a controller that controls the playback circuit to give priority to the visual broadcast program over the digital image data.

45. An image recorder comprising:
a first receiver that receives data of a visual broadcast program;
a second receiver that receives a digital still image data taken by a digital still camera;
a storage that stores both the data of visual broadcast program and the digital still image data;
a playback that plays back the data in the storage; and
a manually operable controller that controls the playback both on the basis of the data of visual broadcast program and on the basis of the digital still image data.

46. An image recorder comprising:
a first receiver that receives data of a visual broadcast program;
a second receiver that receives a digital still image data taken by a digital still camera;
a storage capable of storing both the data of visual broadcast program and the digital still image data;
a recording circuit capable of recording both the data of visual broadcast program and the digital still image data into the storage; and
a manually operable controller that controls the recording circuit both upon recording the data of visual broadcast program and on recording the digital still image data.

47. The image recorder according to claim 46 wherein the second receiver includes a memory slot into which a removable memory coming from the digital still camera is capable of being inserted.

48. An image recorder comprising:
a built-in memory of a large capacity that stores a plurality of image data;
a memory slot into which a removable memory is capable of being inserted;
a detector capable of detecting the insertion of the removable memory in the memory slot;
a power circuit that supplies electric power to the image recorder: and
a power controller that controls the power circuit to supply electric power automatically in response to the detector detecting the insertion of removable memory.

49. An image recorder comprising:
a built-in memory of a large capacity that stores a plurality of image data;
a memory slot in which a removable memory is capable of being inserted;
a detector capable of detecting the insertion of the removable memory in the memory slot; and
a receiver that receives the image data from the removable memory to the built-in memory; and
a controller that controls the receiver to start reception of the image data from the removable memory to the built-in memory in response to the detector detecting the insertion of removable memory.

50. An image recorder comprising:
a built-in memory of a large capacity that stores a plurality of image data;
a memory slot in which a removable memory is capable of being inserted;
a receiver that receives the image data from the removable memory;
a recording circuit that records the digital image data into the built-in memory;
a playback circuit that plays back the digital image data stored in the built-in memory; and
a controller that gives priority to the playback circuit over the recording circuit.

51. An image recorder comprising:
a built-in memory of a large capacity that stores a plurality of image data;
a memory slot in which a removable memory is capable of being inserted;
a playback circuit that plays back the image data stored the built-in memory;
a receiver that receives the image data from the removable memory to the built-in memory; and
a controller that controls the playback circuit to play back the image data even if the receiver is in the course of receiving the image data.

52. An image recorder comprising:
a receiver that receives data of a visual broadcast programs;
a memory slot into which a removable memory coming from a digital camera is capable of being inserted for receiving digital image data taken by the digital camera;
a storage capable of storing both the data of the visual broadcast program and the digital image data;
a recording circuit that records the digital image data into the storage so as to be distinguishable from the data of visual broadcast program upon accessing the data in the storage.
